(19) United States
(12) Patent Application Publication
(10) Pub. No.: US 2017/0207640 A1
(43) Pub. Date: Jul. 20, 2017

(54) METHOD AND SYSTEM FOR MANAGING BATTERY ASSEMBLY

(71) Applicant: SZ DJI Technology Co., Ltd., Shenzhen City (CN)

(72) Inventors: Lei Wang, Shenzhen City (CN); Wentao Wang, Shenzhen City (CN); Dayang Zheng, Shenzhen City (CN); Yuancai Liu, Shenzhen City (CN); Juncheng Zhan, Shenzhen City (CN)

(21) Appl. No.: 15/476,662

(22) Filed: Mar. 31, 2017

Related U.S. Application Data
(63) Continuation of application No. PCT/CN2015/100198, filed on Dec. 31, 2015.

(51) Int. Cl. H02J 7/00

(52) U.S. Cl. CPC H02J 7/0021; H02J 7/0014

(57) ABSTRACT

Methods and systems for forming and changing electrical connections between a plurality of batteries (1041˜2046, 2041˜2046, 3041˜3046, 6041, 6043˜6046, 8041, 8043, 8044, 8046) within a battery assembly (100, 200, 300, 600, 800) are provided to balance the battery properties. The batteries (1041˜2046, 2041˜2046, 3041˜3046, 6041, 6043˜6046, 8041, 8043, 8044, 8046) having similar properties may be grouped into one battery pack, and an adjustment to existence of electrical connections between the plurality of batteries (1041˜2046, 2041˜2046, 3041˜3046, 6041, 6043˜6046, 8041, 8043, 8044, 8046) may be enabled while the battery assembly (100, 200, 300, 600, 800) is powering the object.

### CROSS-REFERENCE

This application is a continuation of International Application No. PCT/CN2015/100198, filed on Dec. 31, 2015. The above-referenced application is hereby incorporated by reference.

### BACKGROUND

Battery assemblies may be used to provide power to stationary or movable objects such as ground vehicles, air vehicles, surface vehicles, underwater vehicles, and spacecraft. The battery assembly for movable objects, such as an unmanned aerial vehicle (UAV), may be managed by a battery management system (BMS).

However, batteries within a battery assembly may have different properties such as capacity and voltage, in which case the discharging of batteries may not be balanced. In some instances, one or more batteries within a battery assembly may fail during operation, causing a malfunction or even crash of the UAV.

### SUMMARY OF THE INVENTION

Methods and systems are provided for managing a battery assembly used to power an object, such as an unmanned aerial vehicle (UAV). In some instances, the plural of batteries within a battery assembly may have difference in properties such as capacity, voltage, lifetime, etc., in which case the discharging of batteries may not be balanced and a lifetime of the batteries may be shortened. Accordingly, in order to balance the properties and discharging of the batteries within the battery assembly, a need exists for methods and systems for managing a battery assembly that activate only those batteries having similar battery properties and isolate other batteries having a difference in battery properties exceeding a predetermined threshold. In the battery management methods and systems provided herein, only those batteries having similar battery properties may be activated to form an electrical circuit of the battery assembly and power the object. As a result, the discharging of the batteries may be balanced and the overall electrical performance of the battery assembly may be improved.

Furthermore, methods and systems for managing a battery assembly are provided, that enable an adjustment to existence of electrical connections between the plurality of batteries within the battery assembly if one or more batteries are in fault or a property of the one or more batteries goes outside an appropriate range while the battery assembly is powering the object. The faulty battery may be isolated from the existing electrical circuit, the electrical connection of the battery assembly may be adjusted and the output performance of the battery assembly may not be affected. This may occur while an object powered by the battery assembly is in operation to reduce interference with normal operation of the object.

Management of a battery assembly may also include balancing a property of each battery pack within the battery assembly and increasing the electrical performance of the battery assembly. The battery assembly may comprise one or more battery packs connected in series and each battery pack may comprise a plurality of batteries connected in parallel. The battery having a higher property, such as voltage, than others in one battery pack may be discharged with larger current until a difference in the property of each battery in the battery pack is less than a predetermined threshold. By discharging one or more batteries in a manner different from the others in one battery pack, the property of the batteries may be maintained consistently with each other and the electrical performance of each battery may be improved.

An aspect of the disclosure may provide a method of managing a battery assembly used to power at least part of an object, the battery assembly comprising a plurality of batteries, the method comprising obtaining a property of each of the plurality of batteries; and generating a signal, with aid of one or more processors and based upon a property of each of the plurality of batteries, that causes the formation of electrical connections between the plurality of batteries to form a first number of battery packs that are connected in series, each battery pack having one or more batteries connected in parallel.

In some instances, each battery pack may have a second number of batteries connected in parallel. The first number and the second number may be the same. Alternatively, the first number and the second number may be different. In some examples, the first number may be an integer of two or more, and the second number may be an integer of two or more. In some embodiments, the first number may be selected based on the property of each of the plurality of batteries, and the second number may be selected based on the property of each of the plurality of batteries. Alternatively, the first number may be predetermined, and the second number may be predetermined.

The property of battery may be selected from the group consisting of a voltage, a capacity, a discharge current and a discharging cycle. The one or more batteries of a battery pack may be grouped such that a difference in the property of each battery in the battery pack is less than a predetermined threshold. In some instances, the property of battery may be voltage, and the predetermined threshold may be 0.2V. Alternatively, the property of battery may be capacity, and the predetermined threshold may be 10 mAh. Alternatively, the property of battery may be discharging cycle, and the predetermined threshold may be 50 discharging cycles.

The method of an aspect of the disclosure may further comprise forming, in response to the signal, the electrical connections between the plurality of batteries to form the first number of battery packs that are connected in series, each battery pack having one or more batteries connected in parallel.

The method of an aspect of the disclosure may further comprise isolating a battery of which a difference in the property of battery as compared to other batteries is larger than a predetermined threshold. In some instances, the property of battery may be voltage, and the battery of which a difference in the voltage as compared to other batteries within the battery pack being larger than a predetermined threshold may be isolated. For example, the predetermined threshold may be 0.2V. Alternatively, the property of battery may be capacity, and the battery of which a difference in the capacity as compared to other batteries within the battery pack being larger than a predetermined threshold may be isolated. For example, the predetermined threshold may be 10 mAh. Alternatively, the property of battery may be discharging cycle, and the battery of which a difference in the discharging cycle as compared to other batteries within the battery pack being larger than a predetermined threshold may be isolated. For example, the predetermined threshold may be 50 discharging cycles. In some instances, the method of an aspect of the disclosure may further comprise sending an alert that a battery is faulty. The alert may be provided to a remote controller of the object. The alert may indicate an identity of the faulty battery that is isolated.

The method of an aspect of the disclosure may further comprise isolating a battery within a battery pack of which a difference in the property of battery as compared to other batteries within the battery pack is larger than a predetermined threshold. In some instances, the property of battery may be voltage, and the battery of which a difference in the voltage as compared to other batteries within the battery pack being larger than a predetermined threshold may be isolated. For example, the predetermined threshold may be 0.2V. Alternatively, the property of battery may be capacity, and the battery of which a difference in the capacity as compared to other batteries within the battery pack being larger than a predetermined threshold may be isolated. For example, the predetermined threshold may be 10 mAh. Alternatively, the property of battery may be discharging cycle, and the battery of which a difference in the discharging cycle as compared to other batteries within the battery pack being larger than a predetermined threshold may be isolated. For example, the predetermined threshold may be 50 discharging cycles. In some instances, the method of an aspect of the disclosure may further comprise sending an alert that a battery is faulty. The alert may indicate an update in estimated remaining time of operation of the object after the faulty battery is isolated. The alert may be provided to a remote controller of the object.

In some instances, the method of an aspect of the disclosure may further comprise isolating a battery which is faulty. In some instances, the method of an aspect of the disclosure may further comprise powering at least part of the object by the battery assembly having the first number of battery packs connected in series. The object may be a movable object, for example, a UAV.

Aspects of the disclosure may also provide a system for managing a battery assembly used to power at least part of an object, the battery assembly comprising a plurality of batteries, the apparatus comprising: one or more processors that are individually or collectively configured to: obtain a property of each of the plurality of batteries; and generate a signal, based upon the property of each of the plurality of batteries, that causes the formation of electrical connections between the plurality of batteries to form a first number of battery packs that are connected in series, each battery pack having one or more batteries connected in parallel.

In some embodiments, the system of aspects of the disclosure may further comprise a detector configured to detect the property of each of the plurality of batteries. The system of aspects of the disclosure may further comprise the plurality of batteries capable of being connected in series or parallel with one another. In some examples, at least one of the batteries may include a plurality of cells connected in parallel and/or in series. In other examples, each of the plurality of batteries includes a plurality of cells connected in parallel and/or in series.

In some instances, each battery pack may have a second number of batteries connected in parallel. The first number and the second number may be the same. Alternatively, the first number and the second number may be different. In some examples, the first number may be an integer of two or more, and the second number may be an integer of two or more. In some embodiments, the first number may be selected based on the property of each of the plurality of batteries, and the second number may be selected based on the property of each of the plurality of batteries. Alternatively, the first number may be predetermined, and the second number may be predetermined.

The property of battery may be selected from the group consisting of a voltage, a capacity, a discharge current and a discharging cycle. The one or more batteries of a battery pack may be grouped such that a difference in the property of each battery in the battery pack is less than a predetermined threshold. In some instances, the property of battery may be voltage, and the predetermined threshold may be 0.2V. Alternatively, the property of battery may be capacity, and the predetermined threshold may be 10 mAh. Alternatively, the property of battery may be discharging cycle, and the predetermined threshold may be 50 discharging cycles.

The one or more processors of the system may be further configured to form, in response to the signal, the electrical connections between the plurality of batteries to form the first number of battery packs that are connected in series, each battery pack having one or more batteries connected in parallel.

The one or more processors of the system may be further configured to isolate a battery of which a difference in the property of battery as compared to other batteries is larger than a predetermined threshold. In some instances, the property of battery may be voltage, and the battery of which a difference in the voltage as compared to other batteries within the battery pack being larger than a predetermined threshold may be isolated. For example, the predetermined threshold may be 0.2V. Alternatively, the property of battery may be capacity, and the battery of which a difference in the capacity as compared to other batteries within the battery pack being larger than a predetermined threshold may be isolated. For example, the predetermined threshold may be 10 mAh. Alternatively, the property of battery may be discharging cycle, and the battery of which a difference in the discharging cycle as compared to other batteries within the battery pack being larger than a predetermined threshold may be isolated. For example, the predetermined threshold may be 50 discharging cycles. In some instances, the one or more processors of the system may be further configured to send an alert that a battery is faulty. The alert may be provided to a remote controller of the object. The alert may indicate an identity of the faulty battery that is isolated.

The one or more processors of the system may be further configured to isolate a battery within a battery pack of which a difference in the property of battery as compared to other batteries within the battery pack is larger than a predetermined threshold. In some instances, the property of battery may be voltage, and the battery of which a difference in the voltage as compared to other batteries within the battery pack being larger than a predetermined threshold may be isolated. For example, the predetermined threshold may be 0.2V. Alternatively, the property of battery may be capacity, and the battery of which a difference in the capacity as compared to other batteries within the battery pack being larger than a predetermined threshold may be isolated. For example, the predetermined threshold may be 10 mAh. Alternatively, the property of battery may be discharging cycle, and the battery of which a difference in the discharging cycle as compared to other batteries within the battery pack being larger than a predetermined threshold may be isolated. For example, the predetermined threshold may be 50 discharging cycles. In some instances, the one or more processors of the system may be further configured to send an alert that a battery is faulty. The alert may indicate an update in estimated remaining time of operation of the object after the faulty battery is isolated. The alert may be provided to a remote controller of the object.

In some instances, the one or more processors of the system may be further configured to isolate a battery which is faulty. In some instances, the one or more processors of the system may be further configured to power at least part of the object by the battery assembly having the first number of battery packs connected in series. The object may be a movable object, for example, a UAV.

Aspects of the disclosure may also provide a non-transitory computer readable medium comprising machine executable code that, upon execution by one or more computer processors, implements a method of managing a battery assembly used to power at least part of an object, the battery assembly comprising a plurality of batteries, the non-transitory computer readable medium comprising: program instructions for obtaining a property of each of the plurality of batteries; and program instructions for generating a signal, based upon the property of each of the plurality of batteries, that causes the formation of electrical connections between the plurality of batteries to form a first number of battery packs that are connected in series, each battery pack having one or more batteries connected in parallel.

In some instances, each battery pack may have a second number of batteries connected in parallel. The first number and the second number may be the same. Alternatively, the first number and the second number may be different. In some examples, the first number may be an integer of two or more, and the second number may be an integer of two or more. In some embodiments, the first number may be selected based on the property of each of the plurality of batteries, and the second number may be selected based on the property of each of the plurality of batteries. Alternatively, the first number may be predetermined, and the second number may be predetermined.

The property of battery may be selected from the group consisting of a voltage, a capacity, a discharge current and a discharging cycle. The one or more batteries of a battery pack may be grouped such that a difference in the property of each battery in the battery pack is less than a predetermined threshold. In some instances, the property of battery may be voltage, and the predetermined threshold may be 0.2V. Alternatively, the property of battery may be capacity, and the predetermined threshold may be 10 mAh. Alternatively, the property of battery may be discharging cycle, and the predetermined threshold may be 50 discharging cycles.

The non-transitory computer readable medium of an aspect of the disclosure may further comprise program instructions for forming, in response to the signal, the electrical connections between the plurality of batteries to form the first number of battery packs that are connected in series, each battery pack having one or more batteries connected in parallel.

The non-transitory computer readable medium of an aspect of the disclosure may further comprise program instructions for isolating a battery of which a difference in the property of battery as compared to other batteries is larger than a predetermined threshold. In some instances, the property of battery may be voltage, and the battery of which a difference in the voltage as compared to other batteries within the battery pack being larger than a predetermined threshold may be isolated. For example, the predetermined threshold may be 0.2V. Alternatively, the property of battery may be capacity, and the battery of which a difference in the capacity as compared to other batteries within the battery pack being larger than a predetermined threshold may be isolated. For example, the predetermined threshold may be 10 mAh. Alternatively, the property of battery may be discharging cycle, and the battery of which a difference in the discharging cycle as compared to other batteries within the battery pack being larger than a predetermined threshold may be isolated. For example, the predetermined threshold may be 50 discharging cycles. In some instances, the non-transitory computer readable medium of an aspect of the disclosure may further comprise program instructions for sending an alert that a battery is faulty. The alert may be provided to a remote controller of the object. The alert may indicate an identity of the faulty battery that is isolated.

The non-transitory computer readable medium of an aspect of the disclosure may further comprise program instructions for isolating a battery within a battery pack of which a difference in the property of battery as compared to other batteries within the battery pack is larger than a predetermined threshold. In some instances, the property of battery may be voltage, and the battery of which a difference in the voltage as compared to other batteries within the battery pack being larger than a predetermined threshold may be isolated. For example, the predetermined threshold may be 0.2V. Alternatively, the property of battery may be capacity, and the battery of which a difference in the capacity as compared to other batteries within the battery pack being larger than a predetermined threshold may be isolated. For example, the predetermined threshold may be 10 mAh. Alternatively, the property of battery may be discharging cycle, and the battery of which a difference in the discharging cycle as compared to other batteries within the battery pack being larger than a predetermined threshold may be isolated. For example, the predetermined threshold may be 50 discharging cycles. In some instances, the non-transitory computer readable medium of the disclosure may further comprise program instructions for sending an alert that a battery is faulty. The alert may indicate an update in estimated remaining time of operation of the object after the faulty battery is isolated. The alert may be provided to a remote controller of the object.

In some instances, the non-transitory computer readable medium of the disclosure may further comprise program instructions for isolating a battery which is faulty. In some instances, the non-transitory computer readable medium of the disclosure may further comprise program instructions for powering at least part of the object by the battery assembly having the first number of battery packs connected in series. The object may be a movable object, for example, a UAV.

Aspects of the disclosure may also provide a movable object, comprising one or more propulsion units configured to effect a moving of the movable object; a battery assembly comprising a plurality of batteries configured to power at least part of the movable object; and the system for managing a battery assembly of an aspect of the disclosure, the system is configured to manage the battery assembly.

Aspects of the disclosure may also provide a method of managing a battery assembly used to power at least part of an object, the battery assembly comprising a plurality of batteries, the method comprising: obtaining a property of each of the plurality of batteries while the object is in operation; and generating a signal, with aid of one or more processors and based upon the property of each of the plurality of batteries, that causes an adjustment to existence of electrical connections between the plurality of batteries while the battery assembly is powering at least part of the object.

In some embodiments, the signal may be generated while the battery assembly is powering at least part of the object. The property of each of the plurality of batteries may be obtained while the battery assembly is powering at least part of the object.

In some instances, the adjustment to the existence of electrical connections between the plurality of batteries may include a removal of previously existing electrical connections between the plurality of batteries. For example, a battery within a battery pack, of which a difference in the property of battery as compared to other batteries within the battery pack is larger than a predetermined threshold, may be isolated. In some instances, the adjustment to the existence of electrical connections between the plurality of batteries may include a formation of new electrical connections between the plurality of batteries. In some instances, the plurality of batteries may be formed in a first number of battery packs that are connected in series, each battery pack having one or more batteries connected in parallel. The adjustment to the existence of electrical connections between the plurality of batteries may include connecting one or more batteries from one battery pack to another battery pack.

Aspects of the disclosure may also provide a system for managing a battery assembly used to power at least part of an object, the battery assembly comprising a plurality of batteries, the apparatus comprising: one or more processors that are individually or collectively configured to: obtaining a property of each of the plurality of batteries while the object is in operation; and generating a signal, based upon the property of each of the plurality of batteries, that causes an adjustment to existence of electrical connections between the plurality of batteries while the battery assembly is powering at least part of the object.

The system of the disclosure may comprise a detector configured to detect the property of each of the plurality of batteries. The system of the disclosure may comprise the plurality of batteries capable of being connected in series or parallel with one another. In some instances, at least one of the batteries may include a plurality of cells connected in parallel and/or in series. Alternatively, each of the plurality of batteries may include a plurality of cells connected in parallel and/or in series.

In some embodiments, the signal may be generated while the battery assembly is powering at least part of the object. The property of each of the plurality of batteries may be obtained while the battery assembly is powering at least part of the object.

In some instances, the adjustment to the existence of electrical connections between the plurality of batteries may include a removal of previously existing electrical connections between the plurality of batteries. For example, a battery within a battery pack, of which a difference in the property of battery as compared to other batteries within the battery pack is larger than a predetermined threshold, may be isolated. In some instances, the adjustment to the existence of electrical connections between the plurality of batteries may include a formation of new electrical connections between the plurality of batteries. In some instances, the plurality of batteries may be formed in a first number of battery packs that are connected in series, each battery pack having one or more batteries connected in parallel. The adjustment to the existence of electrical connections between the plurality of batteries may include connecting one or more batteries from one battery pack to another battery pack.

Aspects of the disclosure may also provide a non-transitory computer readable medium comprising machine executable code that, upon execution by one or more computer processors, implements a method of managing a battery assembly used to power at least part of an object, the battery assembly comprising a plurality of batteries, the non-transitory computer readable medium comprising: program instructions for obtaining a property of each of the plurality of batteries while the object is in operation; and program instructions for generating a signal, with aid of one or more processors and based upon the property of each of the plurality of batteries, that causes an adjustment to existence of electrical connections between the plurality of batteries while the battery assembly is powering at least part of the object.

In some embodiments, the signal may be generated while the battery assembly is powering at least part of the object. The property of each of the plurality of batteries may be obtained while the battery assembly is powering at least part of the object.

In some instances, the adjustment to the existence of electrical connections between the plurality of batteries may include a removal of previously existing electrical connections between the plurality of batteries. For example, a battery within a battery pack, of which a difference in the property of battery as compared to other batteries within the battery pack is larger than a predetermined threshold, may be isolated. In some instances, the adjustment to the existence of electrical connections between the plurality of batteries may include a formation of new electrical connections between the plurality of batteries. In some instances, the plurality of batteries may be formed in a first number of battery packs that are connected in series, each battery pack having one or more batteries connected in parallel. The adjustment to the existence of electrical connections between the plurality of batteries may include connecting one or more batteries from one battery pack to another battery pack.

Aspects of the disclosure may also provide a movable object, comprising: one or more propulsion units configured to effect a moving of the movable object; a battery assembly comprising a plurality of batteries configured to power at least part of the movable object; and the system for managing a battery assembly of an aspect of the disclosure, the system is configured to manage the battery assembly.

Aspects of the disclosure may also provide a method of discharging a battery assembly used to power at least part of an object, the battery assembly comprising a plurality of batteries, the method comprising: obtaining a property of each of the plurality of batteries, wherein the plurality of batteries are grouped into a plurality of battery packs, each battery pack having a plurality of batteries; generating, when a battery has a higher property than other batteries in the same battery pack, a signal to discharge the battery having the higher property in a manner different from the other batteries until a difference in the property of each battery in the same battery pack is less than a predetermined threshold; and generating, when the property of each battery in the same battery pack is less than the predetermined threshold, a signal to discharge each of the batteries in the same battery pack in substantially the same manner.

In some instances, the property of each of the plurality of batteries may be a voltage of each of the plurality of batteries. The discharge of the battery having the higher property may be at a higher current than the other batteries in the same battery pack. In some instances, the other batteries may have a discharge current of zero. Alternatively, the other batteries may have a discharge current greater than zero.

Aspects of the disclosure may also provide a system for discharging a battery assembly used to power at least part of an object, the battery assembly comprising a plurality of batteries, the apparatus comprising: one or more processors that are individually or collectively configured to: obtaining a property of each of the plurality of batteries, wherein the plurality of batteries are grouped into a plurality of battery packs, each battery pack having a plurality of batteries; generating, when a battery has a higher property than other batteries in the same battery pack, a signal to discharge the battery having the higher property in a manner different from the other batteries until the property of each battery in the same battery pack is less than a predetermined threshold; and generating, when the property of each battery in the same battery pack is less than the predetermined threshold, a signal to discharge each of the batteries in the same battery pack in substantially the same manner.

The system of the disclosure may further comprise a detector configured to detect the property of each of the plurality of batteries. The system of the disclosure may further comprise the plurality of batteries capable of being connected in series or parallel with one another. In some examples, at least one of the batteries may include a plurality of cells connected in parallel and/or in series. In other examples, each of the plurality of batteries includes a plurality of cells connected in parallel and/or in series.

In some instances, the property of each of the plurality of batteries may be a voltage of each of the plurality of batteries. The discharge of the battery having the higher property may be at a higher current than the other batteries in the same battery pack. In some instances, the other batteries may have a discharge current of zero. Alternatively, the other batteries may have a discharge current greater than zero.

Aspects of the disclosure may also provide a non-transitory computer readable medium comprising machine executable code that, upon execution by one or more computer processors, implements a method of discharging a battery assembly used to power at least part of an object, the battery assembly comprising a plurality of batteries, the non-transitory computer readable medium comprising: program instructions for obtaining a property of each of the plurality of batteries, wherein the plurality of batteries are grouped into a plurality of battery packs, each battery pack having a plurality of batteries; program instructions for generating, when a battery has a higher property than other batteries in the same battery pack, a signal to discharge the battery having the higher property in a manner different from the other batteries until the property of each battery in the same battery pack is less than a predetermined threshold; and program instructions for generating, when the property of each battery in the same battery pack is less than the predetermined threshold, a signal to discharge each of the batteries in the same battery pack in substantially the same manner.

In some instances, the property of each of the plurality of batteries may be a voltage of each of the plurality of batteries. The discharge of the battery having the higher property may be at a higher current than the other batteries in the same battery pack. In some instances, the other batteries may have a discharge current of zero. Alternatively, the other batteries may have a discharge current greater than zero.

Aspects of the disclosure may also provide a movable object, comprising: one or more propulsion units configured to effect a moving of the movable object; a battery assembly comprising a plurality of batteries configured to power at least part of the movable object; and the system for managing a battery assembly of an aspect of the disclosure, the system is configured to manage the battery assembly.

It shall be understood that different aspects of the invention can be appreciated individually, collectively, or in combination with each other. Various aspects of the invention described herein may be applied to any of the particular applications set forth below or for any other types of stationary or movable objects. Any description herein of aerial vehicles, such as unmanned aerial vehicles, may apply to and be used for any movable object, such as any vehicle. Additionally, the systems, devices, and methods disclosed herein in the context of aerial motion (e.g., flight) may also be applied in the context of other types of motion, such as movement on the ground or on water, underwater motion, or motion in space.

Other objects and features of the present invention will become apparent by a review of the specification, claims, and appended figures.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows a battery assembly in accordance with an embodiment of the invention.

FIG. 2 shows an electrical connection between a plurality of batteries within a battery assembly, in accordance with an embodiment of the invention.

FIG. 3 shows a schematic of an interchangeable electrical connection between a plurality of batteries within a battery assembly, in accordance with an embodiment of the invention.

FIG. 4 is a flow chart illustrating a method of grouping a plurality of batteries within a battery assembly onto groups by forming electrical connections between the plurality of batteries, in accordance with an embodiment of the invention.

FIG. 5 is a diagram illustrating an example of a change in voltages of a plurality of batteries while the battery assembly is powering an object, in accordance with an embodiment of the invention.

FIG. 6 shows an electrical connection between the plurality of batteries while one or more batteries are isolated, in accordance with an embodiment of the invention.

FIG. 7 is a diagram illustrating a further example of a change in voltages of a plurality of batteries while the battery assembly is powering an object, in accordance with an embodiment of the invention.

FIG. 8 shows an electrical connection between the plurality of batteries while one or more batteries are isolated, in accordance with an embodiment of the invention.

FIG. 9 is a flow chart illustrating a method of adjusting electrical connections between the plurality of batteries while the battery assembly is power a movable object, in accordance with an embodiment of the invention.

FIG. 10 is a diagram illustrating an example of a change in discharge current of a plurality of batteries within one battery pack of the battery assembly, in accordance with an embodiment of the invention.

FIG. 11 is a flow chart illustrating a method of discharging one or more batteries having a higher property in a manner different from the others in one battery pack, in accordance with an embodiment of the invention.

FIG. 12 illustrates a movable object including a carrier and a payload, in accordance with embodiments of the present invention.

### DETAILED DESCRIPTION OF THE INVENTION

The methods and systems described herein provide an effective approach for balancing the battery properties and forming electrical connections between a plurality of batteries within a battery assembly. The plurality of batteries within the battery assembly may have different battery properties, such as a different voltage or a different capacity. Among the plurality of batteries, only those batteries having similar battery properties, e.g., the difference in output voltages thereof is less than a predetermined value, may be connected in a battery electrical circuit and activated to power an object, such as an unmanned aerial vehicle (UAV), while other batteries having a difference in output voltage exceeding the predetermined threshold may be isolated from the battery electrical circuit. The battery assembly having a plurality of batteries of similar battery properties may provide a stable power to the object, and the performance of each battery may be improved.

The battery management methods and systems may enable an adjustment to electrical connections between the plurality of batteries within the battery assembly while the battery assembly is powering the object. The adjustment to the electrical connections may be necessary if one or more batteries within the battery assembly are in a faulty state. The faulty battery may be identified and isolated from the battery electrical circuit, such that the no fluctuation may happen in the output voltage and current of the battery assembly.

The plurality of batteries within the battery assembly may be grouped into a plurality of battery packs which are connected in series, each battery pack having a plurality of batteries connected in parallel. In alternative configurations, the battery packs may be connected in parallel, or any combination of series and parallel. The batteries within the battery packs may be connected in series, or any combination of series and parallel. The battery management methods and systems may balance the property of the plurality of batteries in one battery pack in which the battery property such as output voltage of the plurality of batteries may vary. The battery having a higher property such as a higher voltage than others in one battery pack may be discharged with larger current until a difference in the voltage of each battery in the battery pack is less than a predetermined threshold. Advantageously, the property of the batteries in one battery pack may be maintained consistent with each other and balanced, and the electrical performance such as output voltage, output current and capacity of each battery may be balanced and improved among one battery pack.

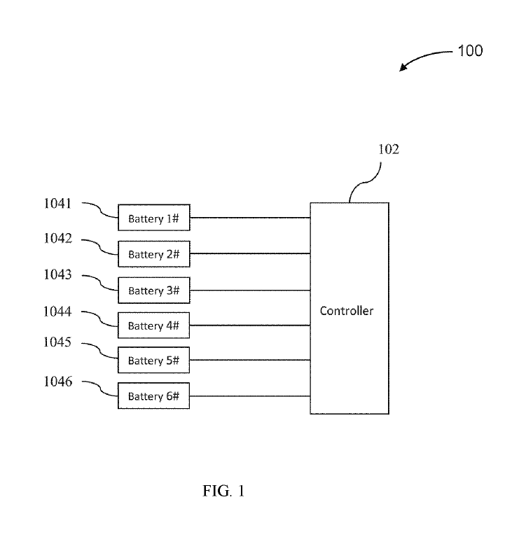

FIG. 1 shows a battery assembly 100 in accordance with an embodiment of the invention. The battery assembly comprises a controller 102 and a plurality of batteries electrically connected to the controller 102, respectively. As an example for illustrative purpose only, six batteries 1041-1046 are shown in FIG. 1. However, any number of batteries may be employed.

The battery assembly of the present disclosure can be adapted to provide power to an object, which may be a movable object or a stationary object. A movable object may be capable of self-propelled movement (e.g., a vehicle), while a stationary object may not be capable of self-propelled movement. The battery assembly can power at least a part of an object, such as one or more electrical components of the object. Examples of electrical components that can be powered by a battery assembly include but are not limited to propulsion systems (e.g., rotors, wheels), sensors (e.g., GPS sensors, inertial sensors, cameras, ultrasonic sensors, infrared sensors, lidar, radar), control systems, communication systems (e.g., receivers, transmitters, transceivers, user interfaces), payloads, and so on.

The movable object may be an unmanned aerial vehicle (UAV). Any description herein of an object, such as a movable object, may apply to any type of movable object, or a stationary object, such as a UAV, and vice versa. The UAV may have one or more propulsion units that may permit the UAV to move about in the air. The UAV may be a rotorcraft. In some instances, the UAV may be a multi-rotor craft that may include a plurality of rotors. The plurality or rotors may be capable of rotating to generate lift for the UAV, enabling the UAV to move about freely through the air (e.g., with up to three degrees of freedom in translation and/or up to three degrees of freedom in rotation). In some embodiments, the battery assembly may be onboard the UAV. The battery assembly may be used to power a propulsion system of the UAV, for example, a rotor of the UAV. Alternatively, the battery assembly may be used to other power electrical components on board the UAV, including but not limited to, control systems (e.g., flight controller), sensors, communication system, payload (e.g., camera, gimbal), etc. Additional examples of movable objects suitable for use with the embodiments of the present disclosure are provided in further detail below.

An object can be powered by any suitable number and combination of battery assemblies. In some embodiments, the object includes only a single battery assembly. In other embodiments, the object includes a plurality of battery assemblies, such as two, three, four, five, or more battery assemblies. The battery assemblies may operate independently of one another or may operate in concert with one another. The battery assemblies may each be managed by a separate battery management system, or a battery management system may mange a plurality of battery assemblies. The battery assemblies may be used to power different systems or operations of an object. Alternatively, a single battery assembly may be used to power different systems or operations of an object, or multiple battery assemblies may be used to power a single system or operation of the object. The battery assemblies can be arranged on the object as desired. For example, a battery assembly can be situated within the interior of object (e.g., within an internal cavity of the object and/or attached to an internal surface of the object) or on the exterior of the object (e.g., on an external surface of the object, such as on a top, bottom, front, back, or side surface). In some embodiments, the battery assembly may be provided within a housing of the object. Alternatively, the battery assembly may be provided outside a housing of the object.

The battery assemblies of the present disclosure can be electrically coupled to at least a part of the object, e.g., via electrical connectors such as wires, cables, pins, contacts, and the like. In some embodiments, the battery assembly is removably coupled to the object, such that the battery can be removed from the object, e.g., for charging, replacement, etc. In alternative embodiments, the battery assembly is permanently affixed to the object and cannot be removed from the object.

The battery assembly may comprise a plurality of batteries. The plurality of batteries within the battery assembly may have the same properties, for example, same nominal discharging voltage, discharge current, capacity, discharging cycle, chemical components, energy density, etc. In some instances, the plurality of batteries within the battery assembly may not have precisely the same properties. For example, a difference may be found in voltages of the plurality of batteries. For another example, a difference may be found in discharge currents of the plurality of batteries. A difference in physical and electrical condition of the batteries may account for the difference in voltage. For instance, a storage condition, a number of discharge-charge, a discharging percentage of the batteries may vary, leading to different physical and electrical condition of the batteries.

The battery packs of a battery assembly can be housed within a single casing of the battery assembly, such that the battery assembly can be provided as a single device, thereby facilitating a handling of the battery assembly, e.g., installing and/or uninstalling the battery assembly as a whole. The single casing of the battery assembly may contain a plurality of compartments, each compartment containing a number of the batteries. The battery packs of a battery assembly can alternatively be housed within different casings, thereby facilitating a changing of respective battery pack. The casing of the battery assembly may be complete enclosed or partly enclosed. The casing of the battery assembly may be manufactured from insulating materials or non-insulating materials. The casing of the battery assembly may be airtight and/or fluid tight. The casing of the battery assembly may provide protection to the components inside, for example, the housing may be shockproof Indicators on status of the batteries inside may be provided on the casing of the battery assembly. In some instances, the indicators may be lights for indicating an operating status and/or remaining power of the battery assembly. In some instances, the battery assembly may be manufactured as an intact battery module having a predetermined number of batteries inside. The battery assembly may be plug and play to the object.

The plurality of batteries within the battery assembly may be grouped into a first number of battery packs connected in series, each battery pack may comprise a second number of batteries connected in parallel. In alternative configurations, the first number of battery packs may be connected in parallel, and the batteries within the battery packs may be connected in series, or any combination of series and parallel. The first number and the second number may be the same. Alternatively, the first number and the second number may be different. For instance, the first number may be an integer of two or more, and the second number may be an integer of two or more.

In some embodiments, the first number and/or the second number may be determined based on the property of each of the plurality of batteries in the battery assembly and/or the required battery property to power at least part of the object. The first number of battery packs connected in series within the battery assembly may be determined by a voltage required to power the object and a voltage output from the battery pack. In some instances, if the voltage required to power a UAV is N V, and the voltage output from one battery pack is M V, then the first number may be at least N/M which is rounded to a larger integer. For example, if the voltage required to power a UAV is 12 V, and the voltage output from one battery pack is 6 V, then the first number may be 2. The second number of batteries connected in parallel within one battery pack may be determined by a capacity required to power the object and a capacity of each battery. For example, if a total capacity of 5200 mAh is required to power a UAV, and the capacity of each battery is 1800 mAh, then the second number may be 3.

Alternatively, the first number and/or the second number may be determined based on the property of each of the plurality of batteries in the battery assembly and the required battery property to power at least part of the object. The required battery property to power at least part of the object may vary in accordance an operating state of the object. For instance, the discharge current to power a UAV may increase when the UAV is accelerating. The first number and/or the second number may be determined in real time when powering the object. For example, the number of batteries in one battery pack, e.g., the second number may be increased in real time when the powered UAV is accelerating in the air.

Alternatively, the first number and/or the second number may be predetermined as battery criteria, as long as the minimum voltage and capacity requirements for powering the object can be satisfied. For instance, the battery criteria may be “minimum 2 battery packs in series, minimum 2 in serials within each battery pack”. If the battery criteria cannot be satisfied, the battery assembly may not be allowed to power the object in a safety consideration, or may not be capable of powering the object due to a lack of voltage/capacity. In some instances, the battery criteria may be a preset criteria. For example, the preset criteria may be determined based upon the property of battery, the property to power the object, power backup, safety, etc. Alternatively, the battery criteria may be determined by the operator of the object. Alternatively, the battery criteria may be determined by an automated process such as an algorithm or a program. In some instances, the battery criteria may be a static criteria during powering the object. Alternatively, the battery criteria may be adjusted in real time to meet a change in powering the object. For example, the battery criteria may be different while the UAV powered by the battery assembly is in an accelerating state or a decelerating state, because the voltage and/or current needed by the UAV is different in various states.

The first number of serially connected battery packs may be predetermined in view of a requirement of voltage backup. In some instances, if the voltage required to power the object is N V, and the voltage output from one battery pack is M V, then the first number may be predetermined as N/M, which is rounded to a larger integer, or larger. For example, if the voltage required to power a UAV is 12 V, and the voltage output from one battery pack is 5 V, then the first number may be predetermined as 3 or more, such that the 12 V requirement can be satisfied even if the output voltage of each battery pack drops over time. For instance, the total voltage of 3 serially connected batteries, each having a 5 V voltage, may be 15 V. In this case, a voltage transformer may be used to output a 12V working voltage to the UAV.

The second number of parallel connected battery within one battery pack may be predetermined in view of a requirement of capacity backup. In some instances, if the capacity required to power a UAV is N mAh, and the capacity of each battery is M mAh, then the second number may be predetermined as at least N/M which is rounded to a larger integer. For example, if the capacity required to power a UAV is 5200 mAh, and the capacity of each battery is 1800 mAh, then the second number may be predetermined as 5, such that the 5200 mAh requirement can be satisfied even if the capacity of each battery pack decreases over time. For instance, the total capacity of 5 parallel connected batteries, each having a capacity of 1800 mAh, may be 9000 mAh.

In some embodiments, the total number of the plurality of batteries may be equal to the product of the first number and second number. Alternatively, the total number of the plurality of batteries may be larger than the product of the first number and second number. In this case, the excess battery or batteries (e.g., the total number−the first number*the second number) may not be connected to the battery circuit to power the object. Alternatively, the excess battery or batteries may be connected to any one of the batteries packs. Alternatively, the excess plural of batteries may be arbitrarily connected to any one or more batteries packs. In some instances, for the purpose, extra batteries may be provided in the battery assembly on purpose. The extra batteries may be disconnected from the electrical circuit of the battery assembly in a normal state, and may be connected to the electrical circuit of the battery assembly any one battery in the battery packs fails.

The batteries within the battery assembly may be any type of suitable battery which is adapted to be mounted on or within the object in order to supply power to one or more electrical components of the object. In some embodiments, the battery may be a rechargeable battery or secondary battery. Alternatively, the battery is a non-rechargeable battery or primary battery. Examples of type of battery suitable for use with the embodiments described herein include but are not limited to: lead-acid batteries, alkaline batteries, nickel-iron batteries, nickel-cadmium batteries, nickel-hydrogen batteries, nickel-metal hydride batteries, nickel-zinc batteries, lithium-air (organic) batteries, lithium cobalt oxide batteries, lithium-ion polymer batteries, lithium iron phosphate batteries, lithium sulfur batteries, lithium-titanate batteries, sodium-ion batteries, thin film lithium batteries, zinc-bromide batteries, zinc-cerium batteries, vanadium redox batteries, sodium-sulfur batteries, molten salt batteries, silver-oxide batteries, or quantum batteries (oxide semiconductor). In some embodiments, the battery assembly may be lithium cobalt oxide batteries.

A battery cell is a unit of battery that converts stored chemical energy into electrical energy. A battery may comprise one or more battery cells. The plurality of battery cells within one battery may be connected in parallel and/or in series. In some instances, the number of battery cells included in one battery may be greater than or equal to 1, 2, 3, 4, 5, 6, 7, 8, 9, 10, 15, 20, 25, 30, 40, 50, 60, 70, 80, 90, 100 or 500. Optionally, the number of battery cells included in one battery may be less than or equal to any of the values described herein.

The battery assembly may provide a voltage to one or more electrical components onboard the object, also referred to herein as an “output voltage.” The output voltage of multiple serially connected batteries may be the sum of voltages of the serially connected batteries. The output voltage of multiple parallel connected batteries may be the voltage of one of the serially connected batteries providing that the voltage of the parallel connected batteries are identical. In some instances, the battery assembly and/or one battery pack may provide an output voltage greater than or equal to about 0.01 V, 0.05 V, 0.1 V, 0.5 V, 1.0 V, 2.0 V, 3.0 V, 4.0 V, 5.0 V, 6.0 V, 7.0 V, 8.0 V, 9.0 V, 10 V, 11 V, 12 V, 13 V, 14 V, 15 V, 16 V, 17 V, 18 V, 19 V, 20 V, 21 V, 22 V, 23 V, 24 V, 25 V, 26 V, 27 V, 28 V, 29 V, 30 V, 35 V, 40 V, 45 V, 50 V, 55 V, 60 V, 65 V, 70 V, 75 V, 80 V, 85 V, 90 V, 95 V, or 100 V. Optionally, the output voltage of the battery assembly may be less than or equal to any of the values described herein. In some embodiments, the maximum output voltage of the battery assembly and/or one battery pack is about 0.01 V, 0.05 V, 0.1 V, 0.5 V, 1.0 V, 2.0 V, 3.0 V, 4.0 V, 5.0 V, 6.0 V, 7.0 V, 8.0 V, 9.0 V, 10 V, 11 V, 12 V, 13 V, 14 V, 15 V, 16 V, 17 V, 18 V, 19 V, 20 V, 21 V, 22 V, 23 V, 24 V, 25 V, 26 V, 27 V, 28 V, 29 V, 30 V, 35 V, 40 V, 45 V, 50 V, 55 V, 60 V, 65 V, 70 V, 75 V, 80 V, 85 V, 90 V, 95 V, or 100 V. In some embodiments, the minimum output voltage of the battery assembly and/or one battery pack is about 0.01 V, 0.05 V, 0.1 V, 0.5 V, 1.0 V, 2.0 V, 3.0 V, 4.0 V, 5.0 V, 6.0 V, 7.0 V, 8.0 V, 9.0 V, 10 V, 11 V, 12 V, 13 V, 14 V, 15 V, 16 V, 17 V, 18 V, 19 V, 20 V, 21 V, 22 V, 23 V, 24 V, 25 V, 26 V, 27 V, 28 V, 29 V, 30 V, 35 V, 40 V, 45 V, 50 V, 55 V, 60 V, 65 V, 70 V, 75 V, 80 V, 85 V, 90 V, 95 V, or 100 V. The maximum and/or minimum output voltages of the battery assembly and/or one battery pack may fall within a range between any two of the values described herein. In some embodiments, the output voltage of the battery assembly may be 11.1 V or 22.2 V.

The amount of electric charge a battery assembly can deliver at a rated voltage may be referred to herein as the battery assembly's “capacity”. The battery assembly and/or one battery pack may have a capacity greater than or equal to about 10 mAh, 50 mAh, 100 mAh, 200 mAh, 400 mAh, 600 mAh, 800 mAh, 1,000 mAh, 1,200 mAh, 1,400 mAh, 1,600 mAh, 1,800 mAh, 2,000 mAh, 2,200 mAh, 2,400 mAh, 2,600 mAh, 2,800 mAh, 3,000 mAh, 3,500 mAh, 4,000 mAh, 4,500 mAh, 5,000 mAh, 6,000 mAh, 7,000 mAh, 8,000 mAh, 9,000 mAh, 10,000 mAh, or 20,000 mAh. Optionally, the capacity of the battery assembly and/or one battery pack may be less than or equal to any of the values described herein. The capacity of the battery may fall within a range between any two of the values described herein. In some embodiments, the capacity of the battery assembly and/or one battery pack may be 4480 mAh, 4500 mAh, 5200 mAh, or 5700 mAh.

A rechargeable battery can be charged and discharged for a number of times. The number of discharge-charge cycles the battery can experience before it fails to meet specific performance may be referred to herein as the battery's “number of charge cycles”. The battery may have a number of charge cycles greater than or equal to about 5, 10, 50, 100, 150, 200, 150, 300, 350, 400, 450, 500, 600, 700, 800, 900, 1,000, 1,200, 1,400, 1,600, 1,800, 2,000, 2,200, 2,400, 2,600, 2,800, 3,000, 3,400, 3,800, 4,000, 4,500, 5,000, 6,000, 7,000, 8,000, 10,000, 20,000, 30,000, 40,000, 50,000, 60,000, 70,000, 80,000, 90,000, or 100,000. Optionally, the charge cycles of the battery may be less than or equal to any of the values described herein. The charge cycles of the battery may fall within a range between any two of the values described herein. In some embodiments, the number of charge cycles of the battery may be 200. The health of the battery assembly may be determined by the battery having the maximum number of charge cycles. The health of the battery assembly may be automatically determined by the controller thereof by reading the number of charge cycles of each batteries and identifying the maximum number of charge cycles.

A lifetime of a battery indicates how long a device can work on one complete charge of a battery. The battery may have a lifetime greater than or equal to 1 s, 20 s, 40 s, 1 min, 5 min, 10 min, 15 min, 20 min, 25 min, 30 min, 35 min, 40 min, 45 min, 50 min, 55 min, 1.0 h, 1.2 h, 1.4 h, 1.6 h, 1.8 h, 2.0 h, 2.5 h, 3.0 h, 3.5 h, 4.0 h, 4.5 h, 5.0 h, 5.5 h, 6.0 h, 6.5 h, 7.0 h, 8 h, 9 h, or 10 h. Optionally, the lifetime of the battery may be less than or equal to any of the values described herein. The lifetime of the battery may fall within a range between any two of the values described herein. In some embodiments, the lifetime of the battery assembly may be 20 min.

A discharge rate of the battery indicates how many hours the battery assembly may discharge before reaching a cut-off voltage, at certain current. The battery may have a discharge rate greater than or equal to about 0.1 h, 0.2 h, 0.4 h, 0.6 h, 0.8 h, 1.0 h, 1.5 h, 2.0 h, 2.5 h, 3.0 h, 3.5 h, 4.0 h, 4.5 h, 5.0 h, 5.5 h, 6.0 h, 6.5 h, 7.0 h, 7.5 h, 8.0 h, 8.5 h, 9.0 h, 9.5 h, 10.0 h, 10.5 h, 11.0 h, 11.5 h, 12.0 h, 12.5 h, 13.0 h, 13.5 h, 14.0 h, 14.5 h, 15.0 h, 15.5 h, 16.0 h, 16.5 h, 17.0 h, 17.5 h, 18.0 h, 18.5 h, 19.0 h, 19.5 h, 20.0 h, 20.5 h, 21.0 h, 21.5 h, 22.0 h, 22.5 h, 23.0 h, 23.5 h, 24.0 h, 24.5 h, 25.0 h, 30.0 h, 35.0 h, or 40.0 h, at a current of 15 A. Optionally, the discharge rate of the battery may be less than or equal to any of the values described herein. In some embodiments, the battery has a maximum discharge rate equal to about 0.1 h, 0.2 h, 0.4 h, 0.6 h, 0.8 h, 1.0 h, 1.5 h, 2.0 h, 2.5 h, 3.0 h, 3.5 h, 4.0 h, 4.5 h, 5.0 h, 5.5 h, 6.0 h, 6.5 h, 7.0 h, 7.5 h, 8.0 h, 8.5 h, 9.0 h, 9.5 h, 10.0 h, 10.5 h, 11.0 h, 11.5 h, 12.0 h, 12.5 h, 13.0 h, 13.5 h, 14.0 h, 14.5 h, 15.0 h, 15.5 h, 16.0 h, 16.5 h, 17.0 h, 17.5 h, 18.0 h, 18.5 h, 19.0 h, 19.5 h, 20.0 h, 20.5 h, 21.0 h, 21.5 h, 22.0 h, 22.5 h, 23.0 h, 23.5 h, 24.0 h, 24.5 h, 25.0 h, 30.0 h, 35.0 h, or 40.0 h, at a current of 15 A. In some embodiments, the battery has a minimum discharge rate equal to about 0.1 h, 0.2 h, 0.4 h, 0.6 h, 0.8 h, 1.0 h, 1.5 h, 2.0 h, 2.5 h, 3.0 h, 3.5 h, 4.0 h, 4.5 h, 5.0 h, 5.5 h, 6.0 h, 6.5 h, 7.0 h, 7.5 h, 8.0 h, 8.5 h, 9.0 h, 9.5 h, 10.0 h, 10.5 h, 11.0 h, 11.5 h, 12.0 h, 12.5 h, 13.0 h, 13.5 h, 14.0 h, 14.5 h, 15.0 h, 15.5 h, 16.0 h, 16.5 h, 17.0 h, 17.5 h, 18.0 h, 18.5 h, 19.0 h, 19.5 h, 20.0 h, 20.5 h, 21.0 h, 21.5 h, 22.0 h, 22.5 h, 23.0 h, 23.5 h, 24.0 h, 24.5 h, 25.0 h, 30.0 h, 35.0 h, or 40.0 h. The battery may have a maximum and/or minimum discharge rate falling within a range between any two of the values described herein. In some embodiments, the discharge rate of the battery is 20 min at a current of 15 A.

In some embodiments, each of the plurality of batteries 1041-1046 may be provided with one or more sensors. The one or more sensors may be capable of detecting one or more properties of the battery. In some embodiments, the property may be selected from the group consisting of voltage, capacity, discharge current, temperature, number of charge cycles, lifetime, discharge rate and state of health. Alternatively, each of the plurality of batteries may be a smart battery with a built-in battery management system (BMS). The smart battery can internally measure the battery properties and communicate with external devices via a bus interface. Alternatively, the plurality of batteries may be a combination of smart batteries and non-smart batteries, in which sensors may be provided to the non-smart batteries to read out the battery properties.

The controller 102 of the battery assembly may be any type of processor operably coupled to the plurality of batteries. In some embodiments, the controller may be provided as part of control circuit of the object such as a UAV, or, it can be provided as an independent circuit, module or chip of the battery assembly. The controller of the battery assembly may be provided within the battery assembly. In alternatively configurations, the controller may be provided outside the battery assembly, for example, the controller may be provided onboard the object to be powered. The communication between the controller and the battery assembly may be implemented by a wired connection or a wireless connection. The wireless connection may be a Bluetooth link, a Wi-Fi link, a Radio-Frequency link, or a cellular communication link. In some instances, the plurality of batteries may be respectively connected to the controller through respective electrical connection. Alternatively, the plurality of batteries may be connected to the controller through a bus connection.

In some embodiments, the controller 102 may be capable of reading the battery properties of the plurality of batteries, grouping the plurality of batteries into groups (e.g., battery packs), changing a formation of electrical connection between the plurality of batteries, sending out an alert, starting/stopping battery recharging, starting/stopping battery discharging, etc. In some instances, the controller of the battery assembly may be communicated with a device controller of an object such as a flight controller of a UAV, transmit the battery properties to the device controller, receive a command from the device controller and control the respective batteries according to the command.

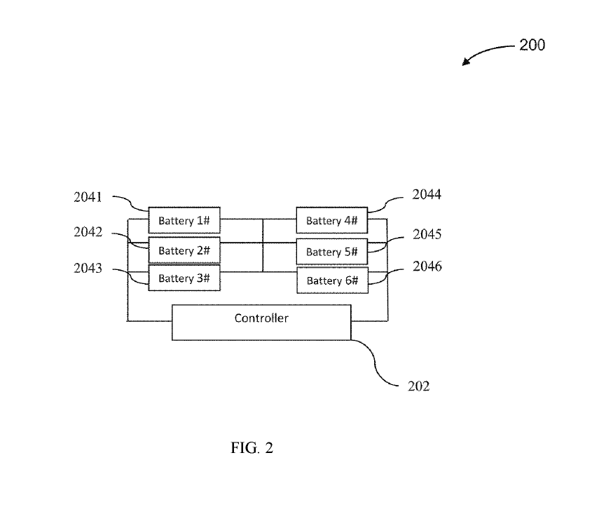

FIG. 2 shows an electrical connection between a plurality of batteries within a battery assembly, in accordance with an embodiment of the invention. In the non-limiting example of FIG. 2, six batteries are shown; however, any number of batteries may be employed. The controller 202 may obtain the property of each of the plurality of batteries 2041-2046, and group the plurality of batteries (for example, the plurality of batteries as shown in FIG. 1) into a first number of battery packs that are connected in serial based upon the property of each of the plurality of batteries. Each battery pack may include a second number of batteries that are connected in parallel. Each battery pack may have the same number of batteries, or one or more of the battery packs may have a different number of batteries.

The property of each of the plurality of batteries may be obtained from sensors that are provided with the batteries, or battery pack or battery assembly, as discussed hereinabove. The controller may group the plurality of batteries into the first number of battery packs based upon the property of each battery, such that a difference in the property of each battery in one battery pack is less than a predetermined threshold. In other words, only those batteries having similar property may be grouped into one battery pack to ensure a balancing in properties of batteries in one battery pack. In some embodiments, the first number may be a predetermined value as required in a preset battery criteria, as discussed hereinabove. For instance, in the non-limiting example of FIG. 2, the first number may be predetermined as 2. Any combination of the batteries can be used to form any combo of packs.

In some embodiments, the difference in the property of each battery in one battery pack being less than a predetermined threshold may require that an absolute difference in the property between any two batteries in one battery pack being less than a predetermined threshold. For example, in the non-limiting example of FIG. 2, it may require that a difference in voltage between battery 1#2041 and battery 2#2042 being less than a predetermined threshold 0.2 V, a difference in voltage between battery 1#2041 and battery 3#2043 being less than a predetermined threshold 0.2 V, and a difference in voltage between battery 2#2042 and battery 3#2043 being also less than a predetermined threshold 0.2 V.

Alternatively, the difference in the property of each battery in one battery pack being less than a predetermined threshold may require that a variance or a standard deviation of the property of the plurality of batteries in one battery pack being less than a predetermined threshold. For example, in the non-limiting example of FIG. 2, it may require that a variance or a standard deviation of voltage values of the battery 1#2041, battery 2#2042 and battery 3#2043 being also less than a predetermined threshold 0.2.

Alternatively, the difference in the property of each battery in one battery pack being less than a predetermined threshold may require that a difference represented in percentage in the property between any two batteries in one battery pack being less than a predetermined threshold. For example, in the non-limiting example of FIG. 2, it may require that a difference represented in percentage in voltage between battery 1#2041 and battery 2#2042 being less than a predetermined threshold 5%, a difference in voltage between battery 1#2041 and battery 3#2043 being less than a predetermined threshold 5%, and a difference in voltage between battery 2#2042 and battery 3#2043 being also less than a predetermined threshold 5%.

The predetermined threshold, which is used to group the plurality of batteries, may be a preset threshold. For instance, the preset threshold may be determined based upon a property of battery, a tolerance of the electrical circuit of the battery pack and/or battery assembly, etc. Alternatively, the threshold may be determined by the operator of the object. Alternatively, the threshold may be determined by an automated process such as an algorithm or a program. In some instances, the threshold may be a static criteria during powering the object. Alternatively, the threshold may be adjusted in real time to meet a change in powering the object. For example, the threshold may be different while the UAV powered by the battery assembly is in an accelerating state or a decelerating state.

In some embodiments, the property of battery may be voltage of battery. In some instances, the predetermined threshold of voltage in determining which batteries can be grouped in one pack may be less than or equal to about 0.001 V, 0.005 V, 0.01 V, 0.05 V, 0.1 V, 0.2 V, 0.3 V, 0.4 V, 0.5 V, 0.6 V, 0.7 V, 0.8 V, 0.9 V, 1.0 V, 1.5 V, 2.0 V, 2.5 V, 3.0 V, 4.0 V, 5.0 V, 6.0 V, 7.0 V, 7.0 V, 8.0 V, 9.0 V, or 10.0 V. Optionally, the predetermined threshold of voltage may be greater than or equal to any of the values described herein. Optionally, the predetermined threshold of voltage may fall within a range between any two of the values described herein. For instance, in the non-limiting example of FIG. 2, the controller may generate a signal to cause the formation of electrical connection between the plurality of batteries to group the plurality of batteries into two packs, such that a difference in voltage of the battery 1#2041, battery 2#2042 and battery 3#2043 in one battery pack being less than a predetermined threshold, for example, 0.2 V; meanwhile, a difference in voltage of the battery 4#2044, battery 5#2045 and battery 6#2046 in another battery pack also being less than the predetermined threshold 0.2 V.

Alternatively, the property of battery may be capacity of battery. In some instances, the predetermined threshold of capacity in determining which batteries can be grouped in one pack may be less than or equal to about 0.001 mAh, 0.005 mAh, 0.01 mAh, 0.05 mAh, 0.1 mAh, 0.5 mAh, 1.0 mAh, 2.0 mAh, 4.0 mAh, 6.0 mAh, 8.0 mAh, 10 mAh, 15 mAh, 20 mAh, 25 mAh, 30 mAh, 40 mAh, 50 mAh, 60 mAh, 70 mAh, 80 mAh, 90 mAh, 100 mAh, 150 mAh, 200 mAh, 300 mAh, 400 mAh or 500.0 mAh. Optionally, the predetermined threshold of capacity may be greater than or equal to any of the values described herein. Optionally, the predetermined threshold of capacity may fall within a range between any two of the values described herein. For instance, in the non-limiting example of FIG. 2, the controller may generate a signal to cause the formation of electrical connection between the plurality of batteries to group the battery 1#2041, battery 2#2042 and battery 3#2043 in one battery pack only if a difference in capacity of the batteries is less than a predetermined threshold, for example 10 mAh.

Alternatively, the property of battery may be discharging cycle of battery. In some instances, the predetermined threshold of discharging cycle in determining which batteries can be grouped in one pack may be less than or equal to about 1 discharging cycle, 5 discharging cycles, 10 discharging cycles, 20 discharging cycles, 30 discharging cycles, 40 discharging cycles, 50 discharging cycles, 60 discharging cycles, 70 discharging cycles, 80 discharging cycles, 90 discharging cycles, 100 discharging cycles, 120 discharging cycles 150 discharging cycles 180 discharging cycles, 200 discharging cycles, 300 discharging cycles, 400 discharging cycles, 500 discharging cycles, 800 discharging cycles, or 1,000 discharging cycles. Optionally, the predetermined threshold of discharging cycle may be greater than or equal to any of the values described herein. Optionally, the predetermined threshold of discharging cycle may fall within a range between any two of the values described herein. For instance, in the non-limiting example of FIG. 2, the controller may generate a signal to cause the formation of electrical connection between the plurality of batteries to group the battery 4#2044, battery 5#2045 and battery 6#2046 in one battery pack only if a difference in discharging cycle of the batteries is less than a predetermined threshold, for example 50 discharging cycle.

The controller 202 may be capable of isolating, among a plurality of batteries, a battery of which a difference in the property of battery as compared to other batteries is larger than a predetermined threshold. In some embodiment, the controller may isolate any battery of which the difference in the property of battery is larger than a predetermined threshold before grouping the plurality of batteries into a first number of battery packs. Alternatively, the controller may isolate any battery of which the difference in the property of battery is larger than a predetermined threshold during the battery assembly powering an object. The difference in the property of battery may be an absolute difference, a variance or a standard deviation in the property of multiple batteries, as disclosed herein above.

The predetermined threshold, which is used to determine which battery is to be isolated from among the plurality, may be a preset threshold. For instance, the preset threshold may be determined based upon a property of battery, a tolerance of the electrical circuit of the battery pack and/or battery assembly, etc. Alternatively, the threshold may be determined by the operator of the object. Alternatively, the threshold may be determined by an automated process such as an algorithm or a program. In some instances, the threshold may be a static criteria during powering the object. Alternatively, the threshold may be adjusted in real time to meet a change in powering the object. For example, the threshold may be different while the UAV powered by the battery assembly is in an accelerating state or a decelerating state.

The threshold, which is used to determine which battery is to be isolated from among the plurality of batteries, may be an absolute difference in the property between any two batteries among the plurality. Alternatively, the threshold may be a variance or a standard deviation of the property of the plurality of batteries. Alternatively, the threshold may be a difference represented in percentage in the property between any two batteries among the plurality.

In some embodiments, the difference in property of battery, based upon which a battery is determined to be isolated from among the plurality of batteries, may be a difference in voltage of battery. For instance, the controller may generate a signal to isolate a battery of which a difference in the voltage as compared to other batteries being larger than a predetermined threshold. Alternatively, the difference in property of battery, based upon which a battery is determined to be isolated from among the plurality of batteries, may be a difference in capacity of battery. Alternatively, the difference in property of battery, based upon which a battery is determined to be isolated from among the plurality of batteries, may be a difference in discharging cycle of battery. For instance, in the non-limiting example of FIG. 2, the controller may generate a signal to change the electrical connection between the plurality of batteries to isolate battery 2#2042 if a difference in the capacity of battery 2#2042 as compared to other batteries is larger than a predetermined threshold, e.g., 10 mAh.

The controller may send an alert that a battery is faulty when a battery is isolated. The alert may be provided to an operator or a remote controller of the object such as a UAV. The alert may be sent through a wired connection or a wireless connection. The wireless connection may be a Bluetooth link, a Wi-Fi link, a Radio-Frequency link, or a cellular communication link. In some instances, the alert may indicate an identity of the faulty battery that is isolated. In some instances, the alert indicates a battery property of the faulty battery that is isolated. The operator of the object may be aware of the faulty battery, and exchange the faulty battery before or after operating the object.

The controller 202 may be capable of isolating a battery within a battery pack of which a difference in the property of battery as compared to other batteries within the battery pack is larger than a predetermined threshold. In some embodiment, the controller may isolate any battery within a battery pack of which the difference in the property of battery is larger than a predetermined threshold after grouping the plurality of batteries into a first number of battery packs. Alternatively, the controller may isolate any battery within a battery pack of which the difference in the property of battery is larger than a predetermined threshold during the battery assembly powering an object. The difference in the property of battery may be an absolute difference, a variance or a standard deviation in the property of multiple batteries, as disclosed herein above.

The predetermined threshold, which is used to determine which battery is to be isolated a battery from one battery pack, may be a preset threshold. For instance, the preset threshold may be determined based upon a property of battery, a tolerance of the electrical circuit of the battery pack and/or battery assembly, etc. Alternatively, the threshold may be determined by the operator of the object. Alternatively, the threshold may be determined by an automated process such as an algorithm or a program. In some instances, the threshold may be a static criteria during powering the object. Alternatively, the threshold may be adjusted in real time to meet a change in powering the object. For example, the threshold may be different while the UAV powered by the battery assembly is in an accelerating state or a decelerating state.

The threshold, which is used to determine which battery is to be isolated from one battery pack, may be an absolute difference in the property between any two batteries within the one battery pack. Alternatively, the threshold may be a variance or a standard deviation of the property of the batteries within the one battery pack. Alternatively, the threshold may be a difference represented in percentage in the property between any two batteries within the one battery pack.

In some embodiments, the difference in property of battery, based upon which a battery is determined to be isolated from other batteries within the battery pack, may be a difference in voltage of battery. For instance, the controller may generate a signal to isolate a battery within the battery pack of which a difference in the voltage as compared to other batteries within the battery pack being larger than a predetermined threshold. Alternatively, the difference in property of battery, based upon which a battery is determined to be isolated from other batteries within the battery pack, may be a difference in capacity of battery. Alternatively, the difference in property of battery, based upon which a battery is determined to be isolated from other batteries within the battery pack, may be a difference in discharging cycle of battery. For instance, in the non-limiting example of FIG. 2, the controller may generate a signal to change the electrical connection between the plurality of batteries to isolate battery 6#2046 if a difference in the discharging cycles of battery 6#2046, as compared to battery 4#2044 and battery 5#2045 within the same battery pack, is larger than a predetermined threshold, e.g., 50 discharging cycles.

The controller may send an alert that a battery is faulty when a battery is isolated within the battery pack. The alert may be provided to an operator or a remote controller of the object such as a UAV. The alert may be sent through a wired connection or a wireless connection. In some instances, the alert may indicate an identity of the faulty battery that is isolated. In some instances, the alert indicates the battery property of the faulty battery that is isolated. In some instances, the alert may indicate an update in estimated remaining time of operation of the object after the faulty battery is isolated. The operator of the object may be aware of the faulty battery, and exchange the faulty battery before or after operating the object.

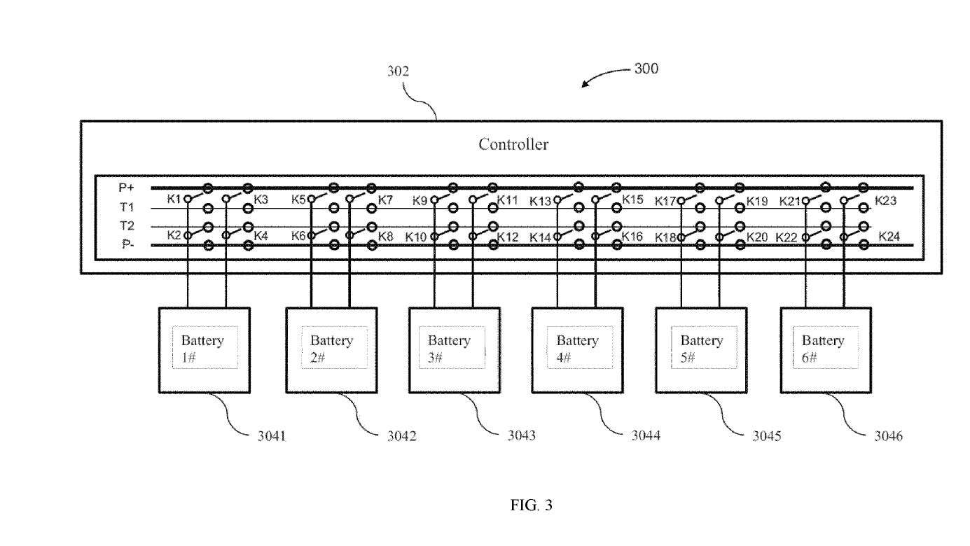

FIG. 3 shows a schematic of an interchangeable electrical connection between a plurality of batteries within a battery assembly, in accordance with an embodiment of the invention. In the non-limiting example of FIG. 3, six batteries are shown; however, any number of batteries may be employed. A positive terminal (or cathode) and a negative terminal (or anode) of each of the plurality of batteries 3041-3046 is connected to a plurality of buses P+, T1, T2 and P− via corresponding ones among a plurality of switches K1-K24, and a connection between terminals of the battery and buses can be switched by controlling a connecting state of the switches. The controller 302 may be capable of controlling a connecting state of each of the plurality of switches. In some instances, one or more sensors (not shown) may be provided with the battery such that a property of the battery may be obtained by the controller.

In the non-limiting example of FIG. 3, for instance, under the control of controller 302, the switch K1 can be put into any one of three connecting states: connected to bus P+, connected to bus T1, connected to neither bus P+ nor bus T1, and the switch K2 can be put into any one of three connecting states: connected to bus P−, connected to bus T2, connected to neither bus P− nor bus T2. Therefore, the positive terminal and the negative terminal of battery 1#3041 can be connected to any one of buses P+, T1, T2 and P−, or can be connected to none of the buses. For example, by controlling a state of the switches K1-K4, the controller may connect the positive terminal of battery 1#3041 to bus P+ and connect the negative terminal of battery 1#3041 to bus T1. In this way, the connection between any two batteries among the plurality of batteries may be changed from a serial connection to a parallel connection, or vice versa, and any battery can be connected to the battery circuit or disconnected from the battery circuit (e.g., isolating).

For instance, the controller may determine to group battery 1#2041, battery 2#2042 and battery 3#2043 into a first battery pack, and to group battery 4#2044, battery 5#2045 and battery 6#2046 into a second battery pack. The first and second battery packs may be connected in series, and the batteries within one battery pack may be connected in parallel. The grouping determination may be made by obtaining a voltage of each battery of the plurality, and then calculating and ensuring that a difference in voltage of three batteries in one battery pack is less than a predetermined threshold. In this non-limiting example, the number of battery packs connected in series and the number of batteries connected in parallel in one battery pack may be predetermined, as discussed herein above. In order to effect this connection, the controller may control the connecting states of the switches as: switches K1, K5 and K9 connecting to bus P+, switches K3, K7 and K11 connecting to bus T1, switches K13, K17 and K21 connecting to bus T1, and switches K16, K20 and K24 connecting to bus P−.

For instance, the controller may determine to group battery 1#2041 and battery 2#2042 into a first battery pack, to group battery 3#2043 and battery 4#2044 into a second battery pack, and to group battery 5#2045 and battery 6#2046 into a third battery pack. The first, second and third battery packs may be connected in series, and the batteries within one battery pack may be connected in parallel. The grouping determination may be made by obtaining a discharging cycle of each battery of the plurality, and then calculating and ensuring that a difference in discharging cycle of two batteries in one battery pack is less than a predetermined threshold. In order to effect this connection, the controller may control the connecting states of the switches as: switches K1 and K5 connecting to bus P+, switches K3, K7, K9 and K13 connecting to bus T1, switches K12, K16, K18 and K22 connecting to bus T1, and switches K20 and K24 connecting to bus P−.

For instance, if battery 2#2042 is faulty, the controller may isolate this battery from the battery circuit by controlling the switch K5 to open (e.g., connecting to neither one of buses P+ nor T2), and/or control any one of the switches K6, K7 and K8 to open. The isolating of a faulty battery may be carried before or during the battery assembly powers the object. In some instances, the faulty battery may be replaced by connecting a new battery to the circuit in a similar way, for example, by connecting the positive and negative terminals the new battery to buses through switches.

The isolating of a battery from among a plurality of batteries within the battery assembly and the isolating of a battery from among batteries within one battery pack may occur in real time while the battery assembly is powering at least part of an object. In some instances, the isolating of a battery from the electrical circuit of the battery assembly may be implemented by controlling a connecting state of the switches without creating a notable variation in powering the object. For example, the variation in output voltage of the battery assembly due to an isolating of a battery within the battery assembly may be less than or equal to about 0.5%, 1%, 2%, 3%, 4%, 5%, 6%, 7%, 8%, 9%, 10%, 15% or 20%. Optionally, variation in output voltage of the battery assembly may be greater than or equal to any of the values described herein. Optionally, the variation in output voltage of the battery assembly may fall within a range between any two of the values described herein.

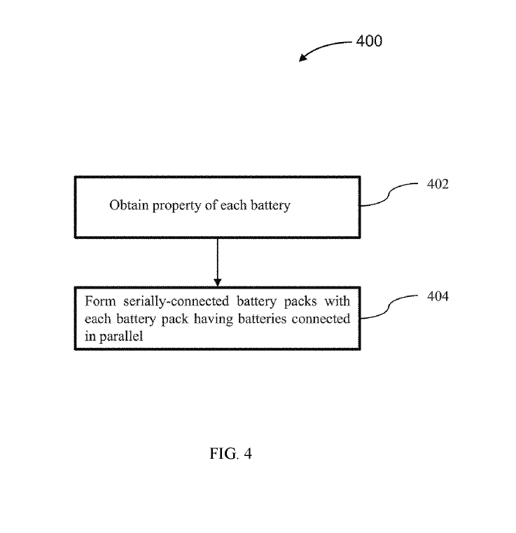

FIG. 4 is a flow chart illustrating a method 400 of grouping a plurality of batteries within a battery assembly onto groups by forming electrical connections between the plurality of batteries, in accordance with an embodiment of the invention. In some embodiments, the plurality of batteries may be grouped into batteries packs based on a property of battery.

In process 402, the property of each of the plurality of batteries may be obtained. The property of battery may be obtained from a sensor of the battery. In some instances, the property of battery may be a voltage, a capacity, a discharging cycle or a combination thereof.

In process 404, the plurality of batteries may be grouped into a first number of battery packs which are connected in series. In some embodiments, each battery pack may include a second number of batteries which are connected in parallel. The first number and second number may be predetermined or dynamically determined, as discussed herein above. In some embodiments, the plurality of batteries may be grouped such that a difference in the property of each battery in any one of the battery packs is less than a predetermined threshold.

In some embodiments, the method may further comprise isolating a battery within a battery pack of which a difference in the property of battery as compared to other batteries within the battery pack is larger than a predetermined threshold. In some instances, the property of battery may be the voltage of battery, and the battery of which a difference in the voltage as compared to other batteries within the battery pack being larger than a predetermined threshold may be isolated (e.g., disconnected) from the battery pack. This isolating may be effected by controlling an electrical connection of the battery to the battery circuit of the battery assembly, for example, by controlling a connecting state of respective switch, as discussed herein above. Alternatively, the property of battery may be the capacity of battery, and the battery of which a difference in the capacity as compared to other batteries within the battery pack being larger than a predetermined threshold may be isolated. Alternatively, the property of battery may be the discharging cycle of battery, and the battery of which a difference in the discharging cycle as compared to other batteries within the battery pack being larger than a predetermined threshold may be isolated.

In some embodiments, the method may further comprise sending an alert that a battery is faulty or isolated. In some instances, the alert may indicate an identity of the faulty battery that is isolated. Alternatively or additionally, the alert may indicate an update in estimated remaining time of operation of the object after the faulty battery is isolated. The alert may be sent to an operator or an operating apparatus of the object which is powered by the battery assembly, for example, a remote controller of a UAV.

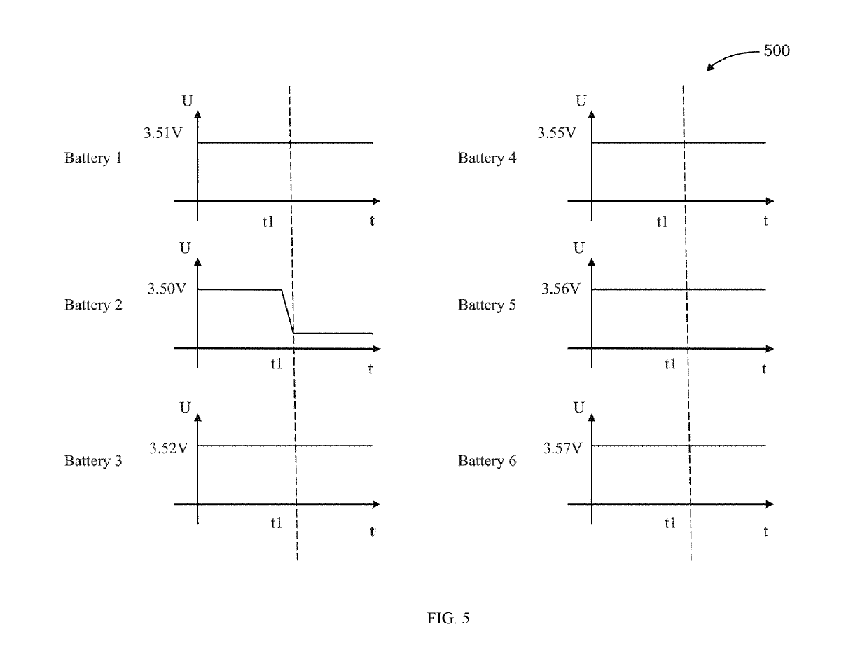

FIG. 5 is a diagram illustrating a change in voltages of a plurality of batteries while the battery assembly is powering an object, in accordance with an embodiment of the invention. The plurality of batteries may be grouped into a first number of battery packs connected in series with each battery pack including a second number of batteries connected in parallel. In some embodiments, the electrical connections between the plurality of batteries may be adjusted or changed while the battery assembly is powering at least part of the object.

In some embodiments, the adjustment to the existence of electrical connections between the plurality of batteries may include a removal of previously existing electrical connections between the plurality of batteries. By the removal of existing electrical connections, a battery within a battery pack, of which a difference in the property of battery as compared to other batteries within the battery pack is larger than a predetermined threshold, may be isolated from the battery assembly. In a non-limiting example shown in FIG. 5, similar to the configuration of FIG. 2, two series connected battery packs may be formed by grouping the battery 1#2041, battery 2#2042 and battery 3#2043 into the first battery pack and grouping the battery 4#2044, battery 5#2045 and battery 6#2046 into the second battery pack. As shown in FIG. 5, each of the batteries within one battery pack may start to power the object with a similar voltage, for example, a difference in voltage of the batteries within one battery pack is less than a predetermined threshold such as 0.2 V. The controller may obtain the property of each of the batteries, and ensure that a difference in property of the batteries within one battery pack does not exceed a predetermined threshold.

For example, during the battery assembly powering the object, the controller of the battery assembly may detect that the difference in voltage of battery within the first battery pack exceeds a predetermined threshold (e.g., 0.2 V) at a timing t1. This may be due to a rapid voltage drop of battery 2#. At this time, the battery 2# may be considered as faulty and may be isolated from the battery circuit. The battery 2# may be isolated (e.g., disconnected) from the battery circuit, for example, by controlling the switch K5 to open, as discussed herein above.

Alternatively, the adjustment to the existence of electrical connections between the plurality of batteries may include a formation of new electrical connections between the plurality of batteries. By the formation of new electrical connections between the plurality of batteries, a new battery may be added to the battery circuit of the battery assembly. For instance, a new battery may be added to the battery assembly by connecting the positive and negative terminals thereof to buses through switches, as discussed herein above.

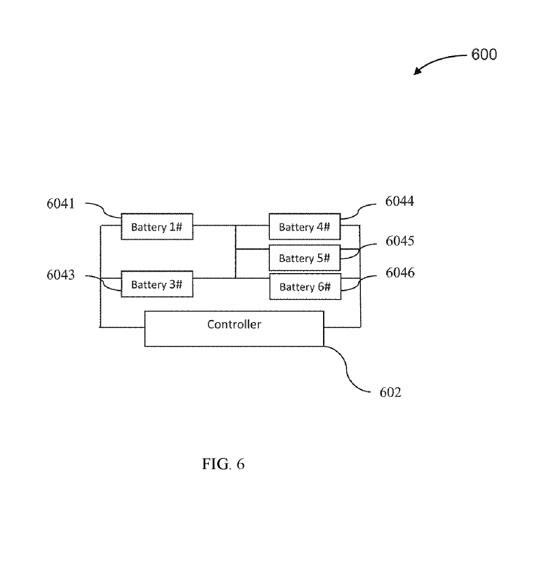

FIG. 6 shows an electrical connection between the plurality of batteries while one or more batteries are isolated, in accordance with an embodiment of the invention.

In some embodiments, one or more batteries may be isolated from the battery assembly while the battery assembly is powering the object such as UAV. In the non-limiting example of FIG. 6, as compared to the circuit configuration of FIG. 2, the battery 2#2042 may be isolated from the first battery pack, such that only two batteries are connected in parallel in the first battery pack. In some instances, the isolating of battery 2# may be a result that the controller of the battery assembly detects that the difference in voltage of battery within the first battery pack exceeds a predetermined threshold while the batter assembly is power the object. The isolating of battery 2# may be effected by controlling the switch K5 to open, as discussed herein above.

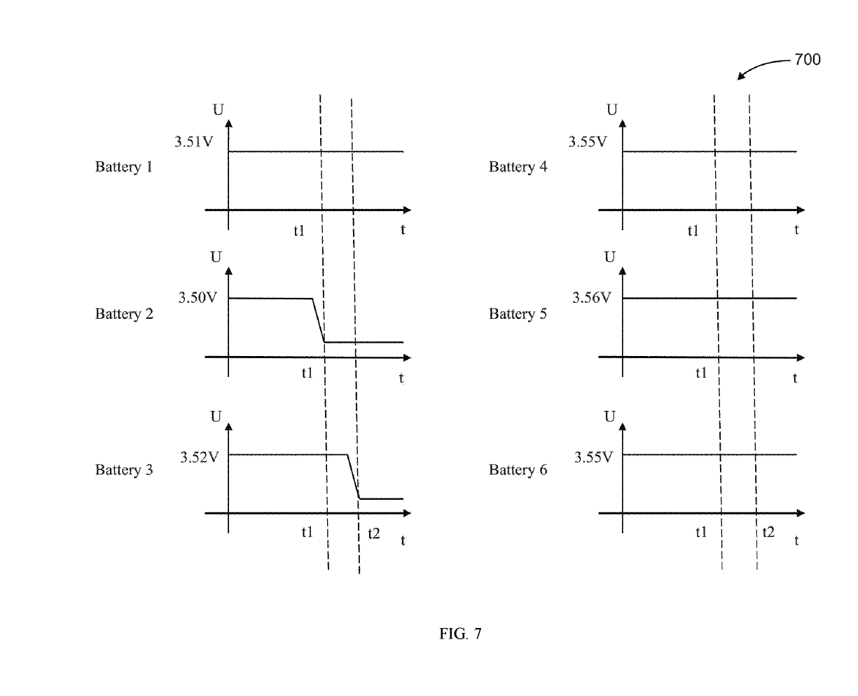

FIG. 7 is a diagram illustrating a further change in voltages of a plurality of batteries while the battery assembly is powering a movable object, in accordance with an embodiment of the invention.

In the non-limiting example of FIG. 7, during the battery assembly powering the object (at this time, only battery 1#2041 and battery 3#2043 are connected in parallel in the first battery pack), the controller of the battery assembly may further detect that the difference in voltage of battery within the first battery pack exceeds a predetermined threshold (e.g., 0.2 V) at a timing t2. This may be due to a malfunction of battery 3#. At this time, the battery 3# may be isolated from the battery circuit. The battery 3# may be isolated (e.g., disconnected) from the battery circuit, for example, by controlling the switch K9 to open, as discussed herein above.

In some instances, a battery criteria, for example “minimum 2 battery packs in series, minimum 2 in serials within each battery pack” may be predetermined to the battery assembly in order to ensure a safety in powering the object. In the non-limiting example of FIG. 7, if the battery 3# is further isolated from the first battery pack, the above battery criteria may not be satisfied. In this circumstance, the controller of the battery assembly may effect an adjustment to the existence of electrical connections between the plurality of batteries by connecting one or more batteries from one battery pack to another battery pack. For instance, the controller may connect another battery (e.g., battery 6#) from the second battery pack to the first battery pack, such that the above battery criteria may be satisfied and the battery assembly can continue to power the object. The shifting of battery 6# may be effected by connecting the switch K21 from bus T1 to bus P+, putting the switch K23 to open and connecting the switch K23 to bus T1.

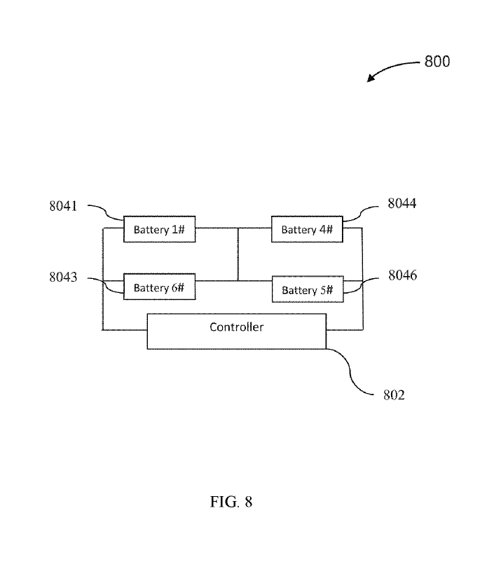

FIG. 8 shows an electrical connection between the plurality of batteries while one or more batteries are isolated, in accordance with an embodiment of the invention. The circuit configuration shown in FIG. 8 may be resulted from isolating battery 2# and battery 3#, and connecting battery 6# from the second battery pack to the first battery pack. In the battery configuration of FIG. 8, the example battery criteria “minimum 2 battery packs in series, minimum 2 in serials within each battery pack” may be satisfied, and the battery assembly can continue to power the object.

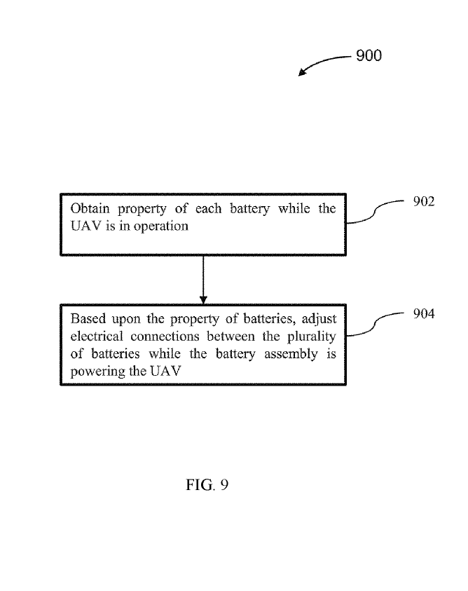

FIG. 9 is a flow chart illustrating a method of adjusting electrical connections between the plurality of batteries while the battery assembly is power a movable object, in accordance with an embodiment of the invention. The plurality of batteries may be grouped into a first number of battery packs that are connected in series with each battery pack including one or more batteries connected in parallel. In some embodiments, based upon the property of each of the plurality of batteries, an adjustment may be made to existence of electrical connections between the plurality of batteries while the battery assembly is powering at least part of the object.

In process 902, the property of each of the plurality of batteries may be obtained. The property of each battery may be obtained from a sensor of the battery. In some instances, the property of battery may be a voltage, a capacity, a discharging cycle or a combination thereof.

In process 904, based upon the property of each of the plurality of batteries, an adjustment may be made to existence of electrical connections between the plurality of batteries while the battery assembly is powering at least part of the object. In some embodiments, the adjustment to the existence of electrical connections between the plurality of batteries may include a removal of previously existing electrical connections between the plurality of batteries, such that a battery may be isolated or removed from the battery assembly. In some instances, a battery within a battery pack, of which a difference in the property of battery as compared to other batteries within the battery pack is larger than a predetermined threshold, may be isolated. Optionally, a battery running into a faulty state may be isolated. Alternatively, the adjustment to the existence of electrical connections between the plurality of batteries may include a formation of new electrical connections between the plurality of batteries, such that a new battery may be connected to the battery assembly. Alternatively, the adjustment to the existence of electrical connections between the plurality of batteries may include connecting one or more batteries from one battery pack to another battery pack which is connected in series. It may also be possible to connect one or more batteries from one battery pack to another battery pack which is connected in parallel.

In some embodiments, a configuration of the circuit of the battery assembly may satisfy a battery criteria. This battery criteria may be predetermined to provide the minimum voltage and capacity for powering at least a part of the object. For instance, the battery criteria may be “minimum 2 battery packs in series, minimum 2 in serials within each battery pack”. In some instances, if any battery pack does not satisfy the battery criteria due to an isolating of one or more batteries within the battery pack, one or more battery may be connected from another battery pack to the one battery pack which is connected in series, such that the battery criteria may be satisfied.

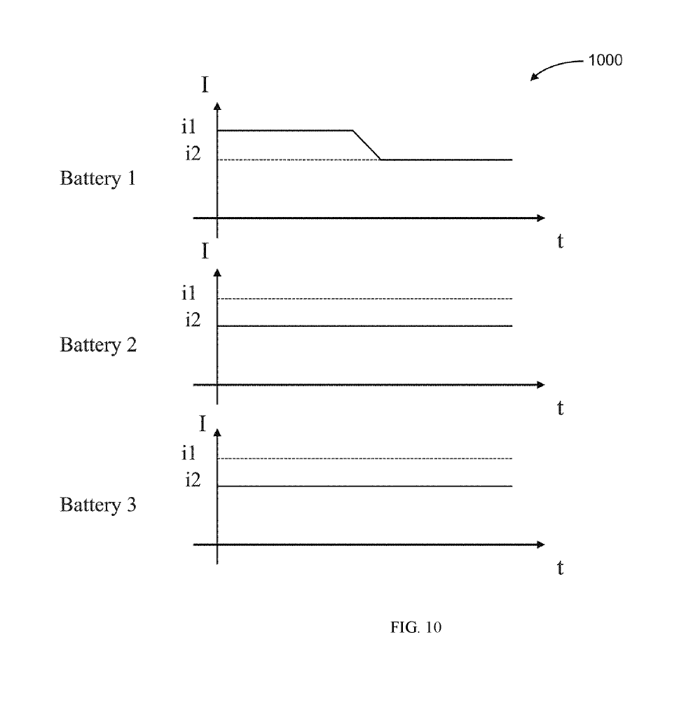

FIG. 10 is a diagram illustrating a change in voltage of a plurality of batteries within one battery pack of the battery assembly, in accordance with an embodiment of the invention. The plurality of batteries may be grouped into a first number of battery packs that are connected in series with each battery pack including one or more batteries connected in parallel. In some embodiments, the number of batteries in the first number of battery packs may be identical. Alternatively, the number of batteries in the first number of battery packs may be different, for example, as long as a predetermined battery criteria is satisfied. Within any one of the battery pack, a battery having a higher property than other batteries in the same battery pack may be discharged in a manner different from the other batteries, until a difference in the property of each battery in the same battery pack is less than a predetermined threshold. Each of the batteries in the same battery pack may then be discharged in substantially the same manner when the property of each battery in the same battery pack is less than the predetermined threshold.

As shown in the non-limiting example shown in FIG. 10, the battery 1#, battery 2# and battery 3# may be grouped into one battery pack. The property of battery 1#, for example the voltage may be higher than that of battery 2# and battery 3#, and a difference in the voltage between battery 1# and batteries 2# and 3# may exceed a predetermined threshold. In order to balance a voltage of batteries within one battery pack, during an initial discharging process, the battery 2# may be discharged in a manner different from discharging the other batteries in the same battery pack. In some instances, only the battery 2# may be discharged while batteries 2# and 3# are not discharged (e.g., the batteries 2# and 3# may have a discharge current of zero), until a difference in the voltage of each battery in the same battery pack is less than the predetermined threshold. Alternatively, all of the batteries 1#, 2# and 3# may be discharged but the battery 1# may be discharged with a larger discharge current than that of batteries 2# and 3#, until a difference in the voltage of each battery in the same battery pack is less than the predetermined threshold. The batteries 1#, 2# and 3# in the same battery pack may then be discharged in substantially the same manner when a difference in the voltage of each battery is less than the predetermined threshold.

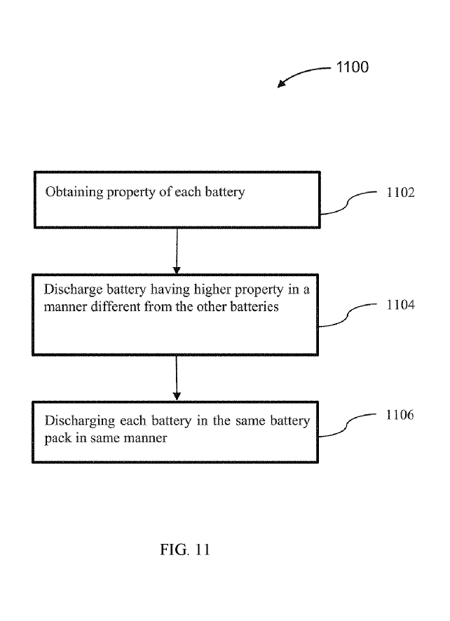

FIG. 11 is a flow chart illustrating a method of discharging one or more batteries having a higher property in a manner different from the others in one battery pack, in accordance with an embodiment of the invention. The plurality of batteries may be grouped into a first number of battery packs that are connected in series with each battery pack including one or more batteries connected in parallel. In some embodiments, each battery pack may include the same number of batteries connected in parallel. Alternatively, the number of batteries in each battery pack may not be the same. For instance, as long as a predetermined battery criteria is satisfied, the number of batteries in each battery pack may differ, as discussed herein above.

In process 1102, the property of each of a plurality of batteries may be obtained. The property of each battery may be obtained from a sensor of the battery. In some instances, the property of battery may be a voltage, a capacity, a discharging cycle or a combination thereof.

In process 1104, based upon the property of each of the plurality of batteries, a battery having a higher property than other batteries in the same battery pack may be discharged in a manner different from the other batteries until a difference in the property of each battery in the same battery pack is less than a predetermined threshold. For instance, any battery within one battery pack of which the voltage is higher than other battery or batteries may be discharged before discharging other battery or batteries, if the difference in voltage is higher than a predetermined threshold. In some embodiments, the battery having a higher property such as voltage may be discharged while the other battery or batteries are not discharged. Alternatively, all the batteries within one battery pack may be discharged while the battery having a higher property may be discharged with a higher discharge current than other battery or batteries.

In process 1106, each battery within the same battery pack may be discharged in substantially the same manner. After the discharging process 1104, the property of each battery within the same battery pack may be substantially the same, for example, a difference in the property of each battery in the same battery pack may be less than a predetermined threshold. The batteries within the same battery pack may be discharged in substantially the same manner to ensure a balance in discharging the batteries. For instance, the batteries within the same battery pack may be discharged with substantially the same discharge current.

In some embodiments, any battery pack having a higher voltage among the plurality of battery packs may be separately discharged before the plurality of battery packs are used to power an object. For instance, if a voltage of a battery pack is higher than that of the other battery packs among the plurality above a predetermined value, the battery pack may be discharged first to decrease the voltage. The discharging may be implemented through one or more bypass resistors that are connected in parallel to the battery pack. The discharging of a battery pack may be executed before or after discharging a battery within one battery pack.

The systems, devices, and methods described herein can be applied to a wide variety of objects, including movable objects and stationary objects. As previously mentioned, any description herein of an aerial vehicle, such as a UAV, may apply to and be used for any movable object. Any description herein of an aerial vehicle may apply specifically to UAVs. A movable object of the present invention can be configured to move within any suitable environment, such as in air (e.g., a fixed-wing aircraft, a rotary-wing aircraft, or an aircraft having neither fixed wings nor rotary wings), in water (e.g., a ship or a submarine), on ground (e.g., a motor vehicle, such as a car, truck, bus, van, motorcycle, bicycle; a movable structure or frame such as a stick, fishing pole; or a train), under the ground (e.g., a subway), in space (e.g., a spaceplane, a satellite, or a probe), or any combination of these environments.

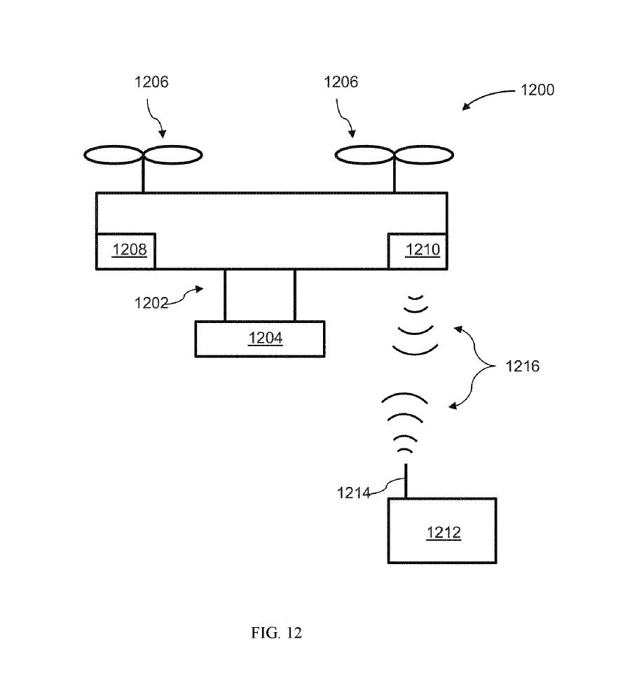

FIG. 12 illustrates a movable object 1200 including a carrier 1202 and a payload 1204, in accordance with embodiments of the present invention. Although the movable object 1200 is depicted as an aircraft, this depiction is not intended to be limiting, and any suitable type of movable object can be used, as previously described herein. One of skill in the art would appreciate that any of the embodiments described herein in the context of aircraft systems can be applied to any suitable movable object (e.g., an UAV). In some instances, the payload 1204 may be provided on the movable object 1200 without requiring the carrier 1202. The movable object 1200 may include propulsion mechanisms 1206, a sensing system 1208, and a communication system 1210.

The propulsion mechanisms 1206 can include one or more of rotors, propellers, blades, engines, motors, wheels, axles, magnets, or nozzles, as previously described. The movable object may have one or more, two or more, three or more, or four or more propulsion mechanisms. The propulsion mechanisms may all be of the same type. Alternatively, one or more propulsion mechanisms can be different types of propulsion mechanisms. The propulsion mechanisms 1206 can be mounted on the movable object 1200 using any suitable means, such as a support element (e.g., a drive shaft) as described elsewhere herein. The propulsion mechanisms 1206 can be mounted on any suitable portion of the movable object 1200, such on the top, bottom, front, back, sides, or suitable combinations thereof.

In some embodiments, the propulsion mechanisms 1206 can enable the movable object 1200 to take off vertically from a surface or land vertically on a surface without requiring any horizontal movement of the movable object 1200 (e.g., without traveling down a runway). Optionally, the propulsion mechanisms 1206 can be operable to permit the movable object 1200 to hover in the air at a specified position and/or orientation. One or more of the propulsion mechanisms 1200 may be controlled independently of the other propulsion mechanisms. Alternatively, the propulsion mechanisms 1200 can be configured to be controlled simultaneously. For example, the movable object 1200 can have multiple horizontally oriented rotors that can provide lift and/or thrust to the movable object. The multiple horizontally oriented rotors can be actuated to provide vertical takeoff, vertical landing, and hovering capabilities to the movable object 1200. In some embodiments, one or more of the horizontally oriented rotors may spin in a clockwise direction, while one or more of the horizontally rotors may spin in a counterclockwise direction. For example, the number of clockwise rotors may be equal to the number of counterclockwise rotors. The rotation rate of each of the horizontally oriented rotors can be varied independently in order to control the lift and/or thrust produced by each rotor, and thereby adjust the spatial disposition, velocity, and/or acceleration of the movable object 1200 (e.g., with respect to up to three degrees of translation and up to three degrees of rotation).

The sensing system 1208 can include one or more sensors that may sense the spatial disposition, velocity, and/or acceleration of the movable object 1200 (e.g., with respect to up to three degrees of translation and up to three degrees of rotation). The one or more sensors can include global positioning system (GPS) sensors, motion sensors, inertial sensors, proximity sensors, or image sensors. The sensing data provided by the sensing system 1208 can be used to control the spatial disposition, velocity, and/or orientation of the movable object 1200 (e.g., using a suitable processing unit and/or control module, as described below). Alternatively, the sensing system 1208 can be used to provide data regarding the environment surrounding the movable object, such as weather conditions, proximity to potential obstacles, location of geographical features, location of manmade structures, and the like.

The communication system 1210 enables communication with terminal 1212 having a communication system 1214 via wireless signals 1216. The communication systems 1210, 1214 may include any number of transmitters, receivers, and/or transceivers suitable for wireless communication. The communication may be one-way communication, such that data can be transmitted in only one direction. For example, one-way communication may involve only the movable object 1200 transmitting data to the terminal 1212, or vice-versa. The data may be transmitted from one or more transmitters of the communication system 1210 to one or more receivers of the communication system 1212, or vice-versa. Alternatively, the communication may be two-way communication, such that data can be transmitted in both directions between the movable object 1200 and the terminal 1212. The two-way communication can involve transmitting data from one or more transmitters of the communication system 1210 to one or more receivers of the communication system 1214, and vice-versa.

In some embodiments, the terminal 1212 can provide control data to one or more of the movable object 1200, carrier 1202, and payload 1204 and receive information from one or more of the movable object 1200, carrier 1202, and payload 1204 (e.g., position and/or motion information of the movable object, carrier or payload; data sensed by the payload such as image data captured by a payload camera). In some instances, control data from the terminal may include instructions for relative positions, movements, actuations, or controls of the movable object, carrier and/or payload. For example, the control data may result in a modification of the location and/or orientation of the movable object (e.g., via control of the propulsion mechanisms 1206), or a movement of the payload with respect to the movable object (e.g., via control of the carrier 1202). The control data from the terminal may result in control of the payload, such as control of the operation of a camera or other image capturing device (e.g., taking still or moving pictures, zooming in or out, turning on or off, switching imaging modes, change image resolution, changing focus, changing depth of field, changing exposure time, changing viewing angle or field of view). In some instances, the communications from the movable object, carrier and/or payload may include information from one or more sensors (e.g., of the sensing system 1208 or of the payload 1204). The communications may include sensed information from one or more different types of sensors (e.g., GPS sensors, motion sensors, inertial sensor, proximity sensors, or image sensors). Such information may pertain to the position (e.g., location, orientation), movement, or acceleration of the movable object, carrier and/or payload. Such information from a payload may include data captured by the payload or a sensed state of the payload. The control data provided transmitted by the terminal 1212 can be configured to control a state of one or more of the movable object 1200, carrier 1202, or payload 1204. Alternatively or in combination, the carrier 1202 and payload 1204 can also each include a communication module configured to communicate with terminal 1212, such that the terminal can communicate with and control each of the movable object 1200, carrier 1202, and payload 1204 independently.

In some embodiments, the movable object 1200 can be configured to communicate with another remote device in addition to the terminal 1212, or instead of the terminal 1212. The terminal 1212 may also be configured to communicate with another remote device as well as the movable object 1200. For example, the movable object 1200 and/or terminal 1212 may communicate with another movable object, or a carrier or payload of another movable object. When desired, the remote device may be a second terminal or other computing device (e.g., computer, laptop, tablet, smartphone, or other mobile device). The remote device can be configured to transmit data to the movable object 1200, receive data from the movable object 1200, transmit data to the terminal 1212, and/or receive data from the terminal 1212. Optionally, the remote device can be connected to the Internet or other telecommunications network, such that data received from the movable object 1200 and/or terminal 1212 can be uploaded to a website or server.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method of managing a battery assembly used to power at least part of an object, said battery assembly comprising a plurality of batteries, said method comprising:
obtaining a property of each of said plurality of batteries; and
generating a signal, with aid of one or more processors and based upon a property of each of said plurality of batteries, that causes the formation of electrical connections between the plurality of batteries to form a first number of battery packs that are connected in series, each battery pack having one or more batteries connected in parallel.

2. The method of claim 1, wherein each battery pack has a second number of batteries connected in parallel.

3. The method of claim 2, wherein the first number or the second number is selected based on the property of each of said plurality of batteries.

4. The method of claim 2, wherein the first number or the second number is predetermined.

5. The method of claim 1, wherein the one or more batteries of a battery pack are grouped such that a difference in the property of each battery in the battery pack is less than a predetermined threshold.

6. The method of claim 1, further comprising forming, in response to the signal, the electrical connections between the plurality of batteries to form the first number of battery packs that are connected in series, each battery pack having one or more batteries connected in parallel.

7. The method of claim 1, further comprising isolating a battery of which a difference in the property of battery as compared to other batteries is larger than a predetermined threshold.

8. The method of claim 7, wherein the property of battery is voltage, capacity or discharging cycle, and the battery of which a difference in the voltage, capacity or discharging cycle as compared to other batteries within the battery pack being larger than a predetermined threshold is isolated.

9. The method of claim 7, further comprising sending an alert that a battery is faulty.

10. The method of claim 1, further comprising isolating a battery within a battery pack of which a difference in the property of battery as compared to other batteries within the battery pack is larger than a predetermined threshold.

11. The method of claim 10, wherein the property of battery is voltage, capacity or discharging cycle, and the battery of which a difference in the voltage, capacity or discharging cycle as compared to other batteries within the battery pack being larger than a predetermined threshold is isolated.

12. The method of claim 1, wherein the object is a movable object.

13. A system for managing a battery assembly used to power at least part of an object, said battery assembly comprising a plurality of batteries, said system comprising:
one or more processors that are individually or collectively configured to:
obtain a property of each of said plurality of batteries; and
generate a signal, based upon the property of each of said plurality of batteries, that causes the formation of electrical connections between the plurality of batteries to form a first number of battery packs that are connected in series, each battery pack having one or more batteries connected in parallel.

14. The system of claim 13, further comprising a detector configured to detect the property of each of said plurality of batteries.

15. The system of claim 13, wherein the one or more batteries of a battery pack are grouped such that a difference in the property of each battery in the battery pack is less than a predetermined threshold.

16. The system of claim 13, wherein the one or more processors are further configured to isolate a battery of which a difference in the property of battery as compared to other batteries is larger than a predetermined threshold.

17. The system of claim 16, wherein the property of battery is voltage, capacity or discharging cycle, and the battery of which a difference in the voltage, capacity or discharging cycle as compared to other batteries being larger than a predetermined threshold is isolated.

18. The system of claim 13, wherein the one or more processors are further configured to isolate a battery within a battery pack of which a difference in the property of battery as compared to other batteries within the battery pack is larger than a predetermined threshold.

19. The system of claim 18, wherein the property of battery is voltage, capacity or discharging cycle, and the battery of which a difference in the voltage, capacity or discharging cycle as compared to other batteries within the battery pack being larger than a predetermined threshold is isolated.

20. A movable object, comprising:
one or more propulsion units configured to effect a moving of the movable object;
a battery assembly comprising a plurality of batteries configured to power at least part of the movable object; and
the system for managing a battery assembly as claimed in claim 13, said system is configured to manage the battery assembly.
